(19) United States
(12) Patent Application Publication
(10) Pub. No.: US 2008/0144052 A1
(43) Pub. Date: Jun. 19, 2008

(54) IMAGE PROCESSING APPARATUS AND IMAGE PROCESSING METHOD

(75) Inventors: Hiroyuki Sakai, Chigasaki-shi (JP); Kiyoshi Umeda, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/875,740

(22) Filed: Oct. 19, 2007

(30) Foreign Application Priority Data
Dec. 12, 2006 (JP) 2006-334431

(51) Int. Cl. G06K 15/00

(52) U.S. Cl. 358/1.5

(57) ABSTRACT

An image processing apparatus receives an image of a print medium including additional information embedded therein and separates a block including the additional information from the received image. The image processing apparatus calculates a determination amount to be used in a determination of contents involved in the additional information, and detects a block position where the additional information is embedded according to the calculated determination amount.

### BACKGROUND OF THE INVENTION

1. Field of the Invention

The present invention relates to an image processing apparatus and a method for controlling the image processing apparatus.

2. Description of the Related Art

For the purpose of preventing unauthorized copy or alteration of an image, an electronic watermark capable of embedding specific information into an image is a useful technique. For example, additional information (hidden information) such as author name and permission to use can be embedded into an electronic image of a photograph or a picture. A technique for embedding additional information into an original image and distributing an image including the additional information via a network (e.g., Internet) is one of prospective techniques to be standardized.

There is a conventional technique that can identify additional information (e.g., type or serial number of a printing device) from an image read from a printed sheet or the like. This technique can prevent any falsification of paper moneys, revenue stamps, and valuable papers that enable users to perform high-quality printing using highly advanced copying machines, printers, and other image forming apparatuses.

For example, a conventional technique can embed additional information into a high-frequency region of a chrominance component and a saturation component of an image which has visually low sensitivity.

However, according to the above-described conventional methods, it is very difficult to embed sound or other bulk information into an image to be printed.

The above-described problem may be solved by the following conventional method that uses a texture artificially generated by an error diffusion method. This method generates a combination of quantization which cannot be obtained by the ordinary halftone processing and embeds a produced code into an image. According to this method, the image quality does not substantially change because a visual change of a texture pattern is negligible compared to the original image. Furthermore, this method can easily multiplex different types of signals by changing a quantization threshold in the error diffusion method.

A conventional image processing system configured to print an image including additional information embedded therein and extract the additional information from a print image is described below.

FIG. 19 is a block diagram illustrating a configuration of a conventional image processing apparatus that can print an image including additional information embedded therein. In FIG. 19, an additional information multiplexing unit 193 inputs arbitrary multi-gradational image information via an input terminal 191 and additional information to be embedded into the image information via an input terminal 192. The additional information (i.e., hidden information) is, for example, copyright relating to image information input via the input terminal 191, photographing information (e.g., shooting date/place, photographer, etc), or other information not relating to the image information (e.g., sound information, text document information, etc).

The additional information multiplexing unit 193 embeds the additional information input via the input terminal 192 into the image information input via the input terminal 191 so that the additional information cannot be visually recognized. Namely, the additional information multiplexing unit 193 divides an input image into an arbitrary number of square blocks each having a size of N pixels×N pixels and embeds additional information into each block of the information. The additional information multiplexing unit 193 outputs image information including additional information to a printer 194 that can print the received image information on a print medium. The printer 194 is, for example, an inkjet printer or a laser printer that can perform halftone processing and realize a gradational expression.

FIG. 20 is a block diagram illustrating a configuration of a conventional image processing apparatus that receives a print image from the image processing apparatus illustrated in FIG. 19 and can extract additional information from the print image. In FIG. 20, an image scanner 201 reads image information printed on a print medium and converts the read image information into image data. The image scanner 201 outputs the image data to an additional information separating unit 202.

The additional information separating unit 202 detects an image area where additional information is embedded according to a conventional image processing method. A representative method for performing the detection processing includes detecting a boundary between a non-image area and an image area based on a difference in density. Then, the additional information separating unit 202 separates additional information from the detected image area. The additional information separating unit 202 outputs the separated additional information via an output terminal 203.

However, the above-described conventional method has the following problems. First, the image information input via the input terminal 191 may not be clear enough to detect a boundary between image and non-image areas based on the difference in density.

Even in such an image including unclear image boundary, it is necessary to accurately input an image area to identify additional information inconspicuously embedded in the image information. However, when a user trims a print image with an image scanner, it is difficult to accurately determine an area to be trimmed.

Furthermore, a conventional method divides an input image into a plurality of square blocks each having a size of N pixels×N pixels and divides additional information into plural information to be multiplexed in respective blocks. Therefore, the additional information separating unit 202 is required to accurately detect the position (coordinate values) of each block with a detection error not exceeding several pixels. If the position detection of each block is rough, the detection accuracy of additional information deteriorates extremely and the additional information cannot be reconstructed accurately.

Hence, to solve the above-described problems, a conventional method includes printing reference marks disposed at predetermined intervals around an image area of an image including additional information, reading a printed image with an image scanner, detecting reference marks from read image information, detecting a block position while correcting a distortion with reference to the detected reference marks, and separating additional information from the corrected image information.

FIG. 23 illustrates a print state of reference marks 233 disposed at predetermined intervals around an image area of an image including additional information. The reference marks 233 are positioned along the entire periphery of the image information 231 printed on a print medium 232. A square block 234 having a size of N pixels×N pixels can be detected with reference to the reference marks 233 formed on the print medium 232.

Recent highly advanced image forming apparatuses, such as copying machines and printers, can realize a borderless printing of an image captured by a digital camera or other imaging apparatus. An image forming apparatus (e.g., a printer) configured to perform a borderless printing can adjust a print image to an appropriate size larger than a print medium so that a peripheral region of the image is cut when the image is printed on the print medium.

The above-described conventional method requires a frame including reference marks positioned around an image area at predetermined intervals. Accordingly, the apparatus may cut the reference marks positioned around an image area together with a peripheral region of an image to be printed. As a result, the above-described conventional method may not detect the reference marks and may not accurately realize block position detection processing.

FIG. 24 illustrates a borderless print state including reference marks 243 positioned at predetermined intervals around an image area of an image including additional information. According to the borderless print state illustrated in FIG. 24, the reference marks 243 positioned at predetermined intervals around the image information 241 are not involved in the area of print medium 242. No reference mark is formed on the print medium 242. The position of a block 244 composed of N pixels×N pixels cannot be detected from the print medium 242 that does not include the reference marks 243. Accordingly, a conventional method using reference marks positioned at predetermined intervals around an image area cannot separate additional information from image information.

In the above-described conventional method, it is ideal to equalize the size of an image to be printed in the borderless printing with the size of a print medium. Furthermore, it is ideal to perform a printing operation so as to eliminate any deviation between the print medium and the image to be printed. According to such an ideal printing operation, a frame including reference marks can be surely printed on a print medium and additional information can be separated from image information. However, a mechanism of a printing apparatus is not so accurate and cannot completely equalize a print image with a print medium in size and position.

There is a conventional method capable of separating additional information from image information without using reference marks positioned around an image area at predetermined intervals. This method includes embedding additional information having the same size as an image area to be printed (without using reference marks), detecting edges of the image area to be printed, detecting edge lines of the image area based on the detected edges, and detecting the additional information.

FIG. 25 illustrates a print state including additional information having the same size as the image area to be printed. An image area where image information 251 is formed is set to an inner region of a print medium 252. According to this method, a square block 253 having a size of N pixels×N pixels is set according to the size of image information 251. If an edge of the image information 251 is detected, the square block 253 of N pixels×N pixels can be detected.

However, similar to the above-described conventional method, according to an apparatus configured to cut a peripheral region of an image to be printed, a position where additional information is embedded may deviate even if an edge can be detected from an image read by an image scanner.

FIG. 26 illustrates a borderless print state including additional information having the same size as the image area to be printed. In the borderless print state illustrated in FIG. 26, a square block 263 of N pixels×N pixels is disposed along an edge line of image information 261. The block 263 of N pixels×N pixels deviates from a print medium 262. Therefore, the block 263 of N pixels×N pixels cannot be detected even if an edge can be detected from an image read by an image scanner. Accordingly, the additional information cannot be separated from the image information.

### SUMMARY OF THE INVENTION

Exemplary embodiments of the present invention are directed to an image processing apparatus configured to receive an image of a print medium including additional information embedded therein and accurately identify the position of the additional information. Exemplary embodiments of the present invention are also directed to a method for controlling the image processing apparatus.

According to an aspect of the present invention, an apparatus is operable to receive an image of a print medium including additional information embedded therein and process the received image. The apparatus includes a determination amount calculating unit configured to calculate a determination amount to be used in a determination of contents involved in the additional information embedded in the received image, and a block position detection unit configured to detect a block position where the additional information is embedded in the received image according to the determination amount calculated by the determination amount calculating unit.

According to still yet another aspect of the present invention, a method for processing an image of a print medium including additional information embedded therein. The method includes calculating a determination amount to be used in a determination of contents involved in the additional information embedded in the received image, and detecting a block position where the additional information is embedded in the received image according to the calculated determination amount.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 is a block diagram illustrating an exemplary configuration of an image processing apparatus that can print image information including additional information embedded therein.

FIG. 2 illustrates a control apparatus that executes an operation of each processing unit.

FIG. 3 is a flowchart illustrating an exemplary operation procedure of the image processing apparatus illustrated in FIG. 1.

FIG. 4 illustrates an exemplary additional information embedding area divided by an additional information multiplexing unit into a plurality of square blocks each having a size of N pixels×N pixels.

FIG. 5 illustrates image information D3 in an image area printed on a print medium.

FIG. 6 is a block diagram illustrating an exemplary configuration of an additional information extracting apparatus according to an exemplary embodiment of the present invention, which inputs a print image read by an image scanner and extracts additional information.

FIG. 7 illustrates an exemplary image read by an image scanner.

FIG. 8 is a block diagram illustrating a detailed configuration of a block position detecting unit.

FIG. 9 is a flowchart illustrating an exemplary operation procedure of the image processing apparatus configured to input a print image read by an image scanner and extract additional information.

FIG. 10 is a flowchart illustrating an operation procedure of each unit in the block position detecting unit.

FIG. 11 is a flowchart illustrating exemplary partial block position detection processing.

FIG. 12 illustrates an exemplary partial block position detection area positioned in an area of image information obtained from the image scanner.

FIG. 13 illustrates an exemplary state where an additional information separation processing area of a partial block position detection area deviates from an additional information embedded block position.

FIG. 14 illustrates an exemplary state where an additional information separation processing area of a partial block position detection area coincides with an additional information embedded block position.

FIG. 15 illustrates exemplary code determination amounts of respective pixels obtained from a partial block position detection area.

FIG. 16 illustrates a relationship between image information input into a block position calculating unit and block position information.

FIG. 17 illustrates a result of block position information calculated on image information.

FIG. 18 is a block diagram illustrating a detailed configuration of a block position detecting unit according to a second exemplary embodiment.

FIG. 19 is a block diagram illustrating a configuration of a conventional image processing apparatus that can print an image including additional information embedded therein.

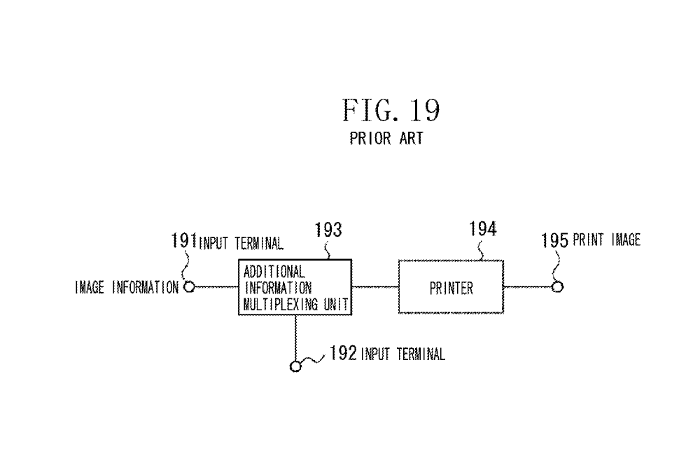

FIG. 20 is a block diagram illustrating a configuration of a conventional image processing apparatus that receives a print image from the image processing apparatus illustrated in FIG. 19 and can extract additional information from the print image.

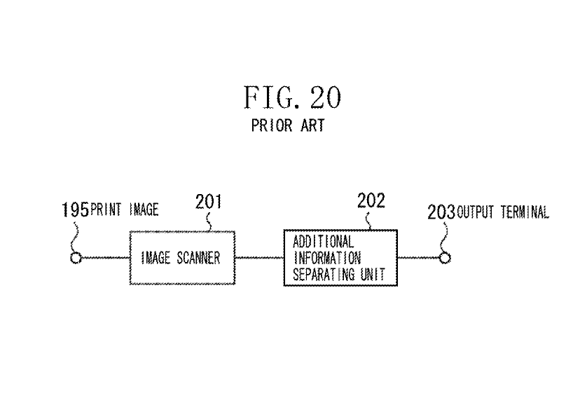

FIG. 21 is a flowchart illustrating an operation procedure of each unit of the block position detecting unit 62 according to the second exemplary embodiment.

FIG. 22 illustrates exemplary processing performed by a detected block position correcting unit.

FIG. 23 illustrates a print state of reference marks disposed at predetermined intervals around an image area of an image including additional information according to a conventional technique.

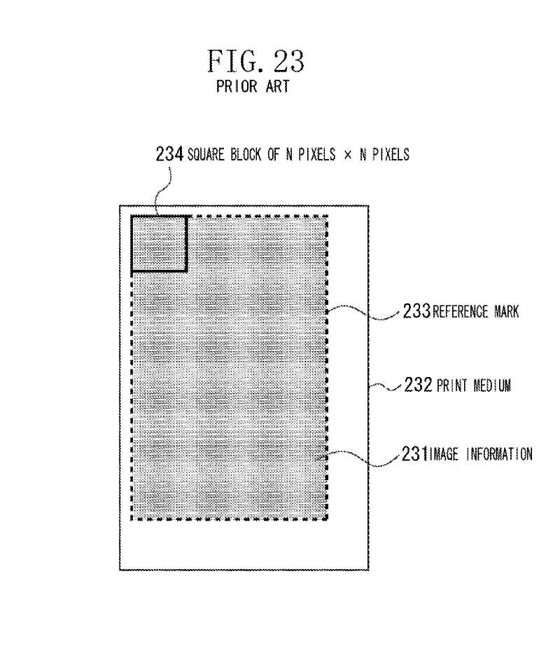

FIG. 24 illustrates a borderless print state including reference marks 243 positioned at predetermined intervals around an image area of an image including additional information according to a conventional technique.

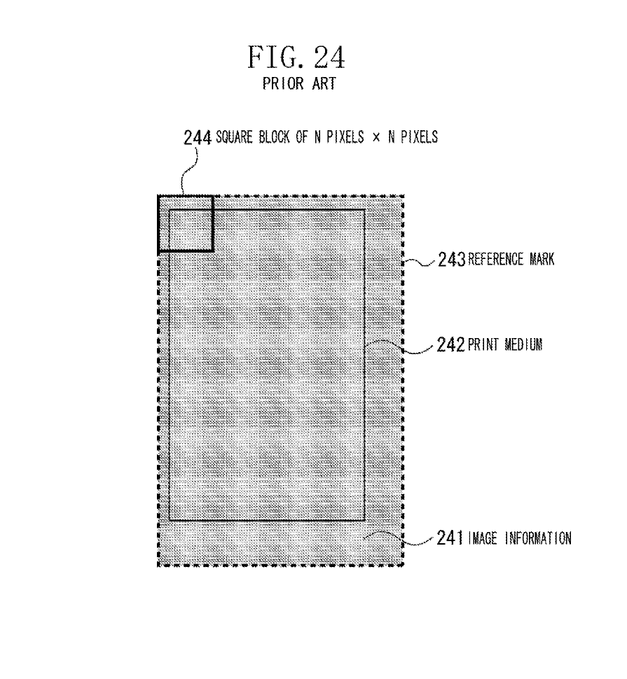

FIG. 25 illustrates a print state including additional information having the same size as an image area to be printed according to a conventional technique.

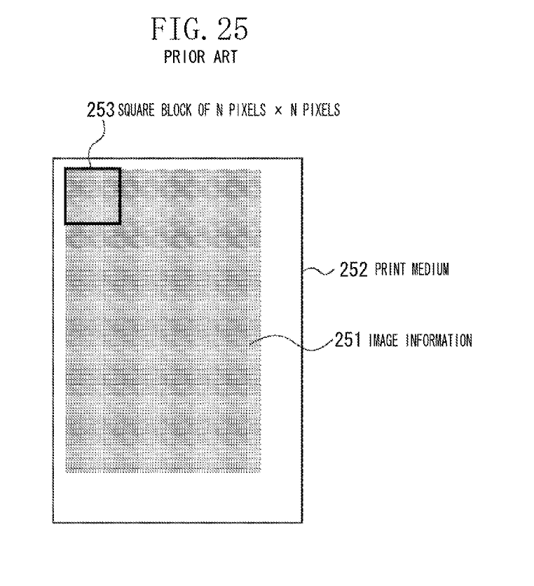

FIG. 26 illustrates a borderless print state including additional information having the same size as an image area to be printed according to a conventional technique.

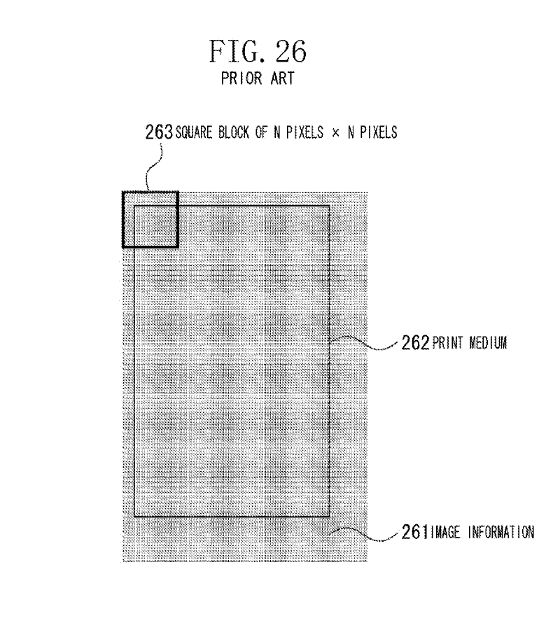

FIG. 27 illustrates image information including additional information embedded in each block.

FIG. 28 illustrates an exemplary case where the number of blocks involved in block position information detected by the block position detecting unit is different from the number of blocks involved in block position information of additional information embedded by an additional information embedding apparatus.

FIG. 29 illustrates exemplary processing performed by the block position detecting unit.

FIG. 30 includes graphs each illustrating a summed-up value of the calculated code determination amounts in each ordinate position and in each abscissa position.

FIG. 31 illustrates a table of calculated summed-up code determination amounts in respective blocks each having a size of 6×6 pixels.

FIG. 32 illustrates an additional information marker and an additional information block.

### DETAILED DESCRIPTION OF THE EMBODIMENTS

The following description of exemplary embodiments is illustrative in nature and is in no way intended to limit the invention, its application, or uses. Processes, techniques, apparatus, and systems as known by one of ordinary skill in the art are intended to be part of the enabling description where appropriate. It is noted that throughout the specification, similar reference numerals and letters refer to similar items in the following figures, and thus once an item is described in one figure, it may not be discussed for following figures. Exemplary embodiments will be described in detail below with reference to the drawings.

An image processing system according to an exemplary embodiment of the present invention includes an additional information embedding apparatus configured to print an image including additional information embedded therein and an additional information extracting apparatus configured to extract additional information from a printed image read by an image scanner.

### First Exemplary Embodiment

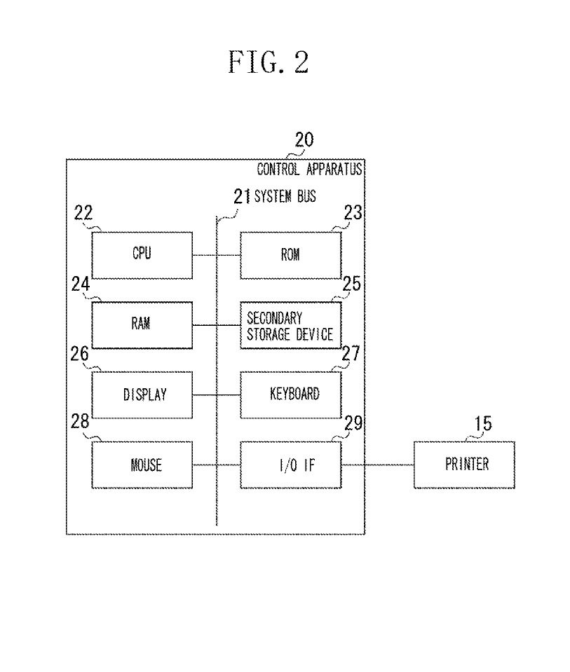

A control apparatus 20 illustrated in FIG. 2 can execute various processing of an additional information embedding apparatus according to an exemplary embodiment of the present invention. In FIG. 2, a central processing unit (CPU) 22, a read only memory (ROM) 23, a random access memory (RAM) 24, a secondary storage device 25 (e.g., a hard disk drive), a display 26, a keyboard 27, a mouse 28, and an input/output (I/O) interface 29 are mutually connected via a system bus 21. The display 26, the keyboard 27, and the mouse 28 are user interfaces. The I/O interface 29 is connected to a printer 15 that can print an image.

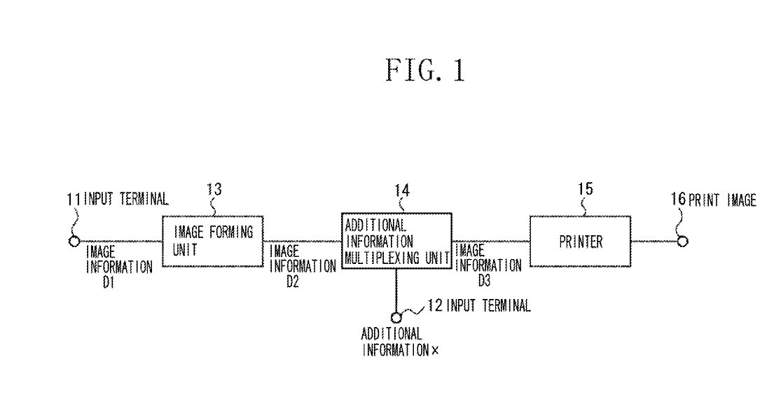

FIG. 1 is a block diagram illustrating an exemplary configuration of an additional information embedding apparatus (an image processing apparatus) according to an exemplary embodiment of the present invention that can print image information including additional information (i.e., hidden information) embedded therein.

The additional information embedding apparatus illustrated in FIG. 1 includes an image forming unit 13 configured to generate an image having a predetermined resolution, an additional information multiplexing unit 14 configured to embed additional information into the image received from the image forming unit 13, and a printer 15 that receives an output image from the additional information multiplexing unit 14 and prints the image on a print medium.

The image forming unit 13 receives, via an input terminal 11, multi-gradational image information D1. The additional information multiplexing unit 14 receives, via an input terminal 12, multi-gradational additional information X to be embedded into the image information D1. The additional information X is information relating to the image information D1 input via the input terminal 11. For example, the additional information X is copyright information relating to the image information D1, type of image file, size of image, data of image information, histogram of image, correction contents of image, Exchangeable Image File Format (EXIF) information of image, or information not relating to the image information D1, such as sound information, text document information, and other image information.

The image forming unit 13 performs resolution conversion processing for adjusting the input image information D1 according to a sheet size or layout information to print an image on a print medium. An exemplary resolution conversion method is a publicly known nearest interpolation or a linear interpolation. Then, the image forming unit 13 outputs image information D2 as resolution converted image information. The image forming unit 13 is connected to the additional information multiplexing unit 14. The additional information multiplexing unit 14 receives the image information D2.

For example, the image forming unit 13 receives Joint Photographic Experts Group (JPEG) image information via the input terminal 11. When a bordered print of the JPEG image information on an L-size sheet is required, the image forming unit 13 sets an image area smaller than the L-size sheet and performs linear interpolation processing on the JPEG image information to convert the resolution according to the image area. If a borderless printing of the JPEG image information on the L-size sheet is required, the image forming unit 13 sets an image area larger than the L-size sheet and performs linear interpolation processing on the JPEG image information to convert the resolution according to the image area. The additional information multiplexing unit 14 receives the resolution converted image information D2.

The additional information multiplexing unit 14 is configured to embed the additional information X into the image information D2 so that the embedded additional information is not visualized when printed. The additional information multiplexing unit 14 performs the following processing so that the additional information X can be reconstructed by analyzing a frequency component of a texture in each block in a decoding process of the additional information.

The additional information multiplexing unit 14 divides an input image area into a plurality of square blocks each having a size of N pixels×N pixels, and changes a quantization threshold of an error diffusion method according to a bit code of the additional information for each block.

This processing enables each block to have a texture that cannot be generated by an ordinary error diffusion method. Thus, the additional information multiplexing unit 14 can embed the additional information X (i.e., hidden information that cannot be recognized by human eyes) into the image information D2. To this end, the additional information multiplexing unit 14 can use a conventional additional information multiplexing method.

The additional information multiplexing unit 14 outputs multiplexed image information D3 including the additional information X embedded in the image information D2. The additional information multiplexing unit 14 is connected to the printer 15. The printer 15 receives the multiplexed image information D3.

The printer 15 forms (prints) the image information D3 on a print medium and outputs as a print image 16. In the present embodiment, it is assumed that the control apparatus 20 illustrated in FIG. 2 is a personal computer and the additional information embedding apparatus illustrated in FIG. 1 is a printing apparatus. It is also assumed that the secondary storage device 25 stores JPEG image data captured by an imaging apparatus and the JPEG image data includes EXIF information.

When a user selects a JPEG image stored in the secondary storage device 25, the JPEG image and EXIF information are loaded into the RAM 24 and displayed on the display 26. Next, the user performs print settings with the keyboard 27 and the mouse 28 while viewing a setting screen on the display 26. The print settings include settings relating to sheet size, print quality, sheet type, layout information, and correction information. Next, the user presses (activates) a print button on the display 26 with the keyboard 27 or the mouse 28. The printing apparatus executes print processing.

During the print processing, the printing apparatus receives the JPEG image information (i.e., image information D1) via the input terminal 11 and the EXIF information (i.e., additional information X) via the input terminal 12.

If a user requests a bordered print on an L-size sheet, the image forming unit 13 performs linear interpolation processing on the JPEG image information (i.e., image information D1) to convert the resolution according to a bordered print image area of the L-size sheet. The additional information multiplexing unit 14 receives the resolution converted image information (i.e., image information D2).

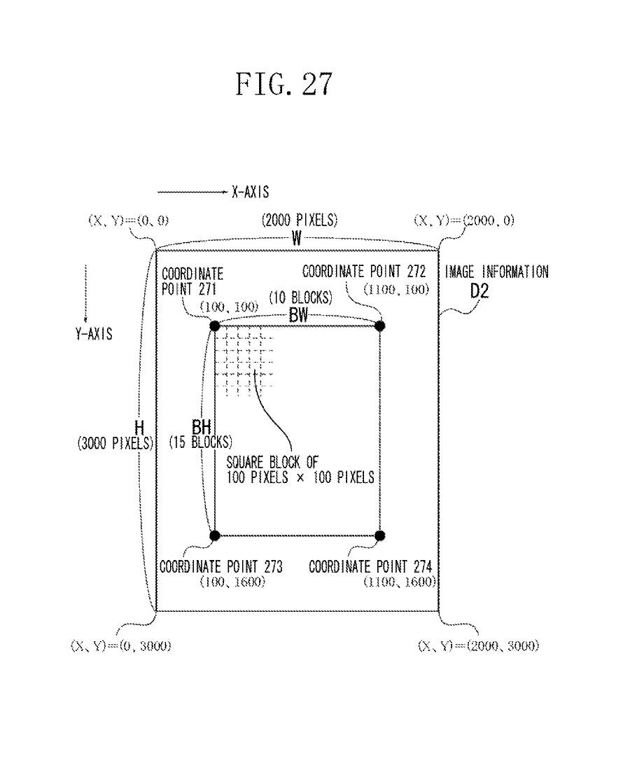

FIG. 27 illustrates the image information D2 including the additional information X embedded in each block. As illustrated in FIG. 27, the additional information multiplexing unit 14 has a resolution equivalent to W pixels (=2000 pixels)×H pixels (=3000 pixels) for the input image information D2. For example, a start point is set to a coordinate point 271 having a coordinate value (X,Y)=(100, 100). The additional information multiplexing unit 14 generates a texture (i.e., additional information X) in each square block having a size equivalent to 100 pixels×100 pixels. The generated texture is a texture unobtainable according to an ordinary error diffusion method. An embedding area of the additional information X has a horizontal size equivalent to BW (=1000 pixels) and a vertical size equivalent to BH (=1500 pixels).

In this case, a total of ten square blocks of 100 pixels×100 pixels are aligned in the X-axis direction from the start point (coordinate point 271) and a total of 15 blocks of 100 pixels×100 pixels are aligned in the Y-axis direction from the start point (coordinate point 271). The additional information embedding area has four vertices defined by the coordinate point 271 (100, 100), coordinate point 272 (1100, 100), coordinate point 273 (100, 1600), and coordinate point 274 (1100, 1600). The additional information embedding area illustrated in FIG. 27 includes a total of 150 blocks (=10 blocks×15 blocks) disposed in a matrix pattern.

If the EXIF information (additional information X) has a bit number of 100 bits, the additional information multiplexing unit 14 can embed 1-bit data into each square block in the following manner. The additional information multiplexing unit 14 divides 100-bit information into a plurality of 1-bit information, changes a quantization threshold of the error diffusion method for each block of 100×100 pixels, and embeds the additional information into the image. The printer 15 receives the image information D3 including the additional information. The additional information embedded in each square block is not limited to 1-bit data and can be plural-bit data.

Furthermore, for the purpose of facilitating extraction of the block position where the additional information is embedded, the additional information multiplexing unit 14 can embed additional information that serves as a marker indicating the position of additional information.

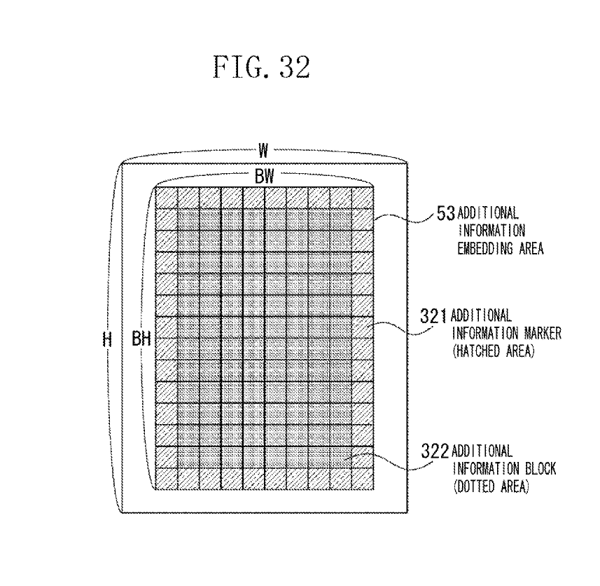

FIG. 32 illustrates an additional information marker 321 and an additional information block 322. The additional information marker 321 is additional information (bit=1′) serving as a marker indicating position information. The additional information block 322 is EXIF information (i.e., additional information other than the additional information marker 321). According to the example illustrated in FIG. 32, the additional information marker 321 extends along the periphery of an additional information embedding area 53 having a size of BW×BH. However, the additional information marker 321 is not limited to a specific pattern and can be modified appropriately. The additional information marker 321 may have additional information other than bit=1′.

The printer 15 forms (prints) an image of the image information D3 on an L-size sheet. According to the above-described exemplary embodiment, the control apparatus 20 is a personal computer constituting an additional information embedding apparatus. However, the control apparatus 20 may be a scanner, a HDD recorder, a digital television, a digital camera, a portable telephone, or any other apparatus that can transmit the image information D1 to the printer 15.

The control apparatus 20 can function as part of the printing apparatus. If the control apparatus 20 functions as part of the printing apparatus, the keyboard and the mouse can be replaced with an interface of the printing apparatus (e.g., a touch panel or operation buttons of the printer) which enables a user to perform settings of the image information D1. Furthermore, a modified combination of various units 21 to 29 may constitute the control apparatus 20 if the printing apparatus can print an image including the additional information X embedded therein.

The image information D1 to be received via the input terminal 11 is not limited to JPEG image information. The additional information X to be received via the input terminal 12 is not limited to EXIF information. For example, the image information D1 may be an image having a bitmap format or an image having a PNG format, or image information of a still image (capturing a frame of a moving image). Furthermore, the additional information X to be received via the input terminal 12 may be sound information having a WAV format, character information (e.g., a shooting date/time of image), GPS information indicating a shooting position, moving image information having a MPEG format, still image information similar to the image information D1, print setting information, histogram information of the image information D1, identifier information, or any other electronic data.

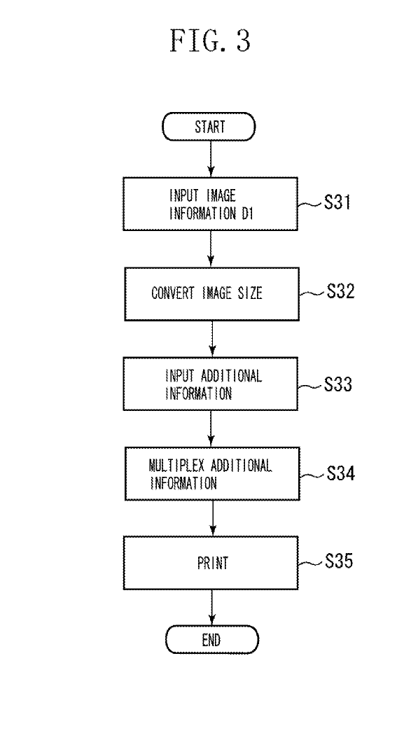

FIG. 3 is a flowchart illustrating an exemplary operation procedure of the image processing apparatus illustrated in FIG. 1. In step S31 (i.e., as an initial step of additional information embedding processing), the image forming unit 13 receives image information D1 via the input terminal 11. In step S32, the image forming unit 13 converts the input image information D1 into image information D2 having a print resolution of H pixels×W pixels. In step S33, the additional information multiplexing unit 14 receives the additional information X via the input terminal 12. The input timing of the additional information X may be identical or prior to the input timing of the image information D1. Alternatively, the additional information multiplexing unit 14 may store the additional information X beforehand.

In step S34, the additional information multiplexing unit 14 sets an additional information embedding area with reference to a size of the image information D2. The additional information multiplexing unit 14 divides the additional information embedding area into a plurality of square blocks each having a size of N pixels×N pixels. Furthermore, the additional information multiplexing unit 14 changes a quantization threshold of the error diffusion method according to a bit code of the additional information for each block, and generates the image information D3.

With the processing of step S34, the additional information multiplexing unit 14 generates a texture (i.e., additional information X) for each square block that cannot be obtained according to an ordinary error diffusion method. The additional information multiplexing unit 14 embeds the additional information X into the image information D2 so that the additional information X can be reconstructed by analyzing a frequency component of the texture in a decoding operation.

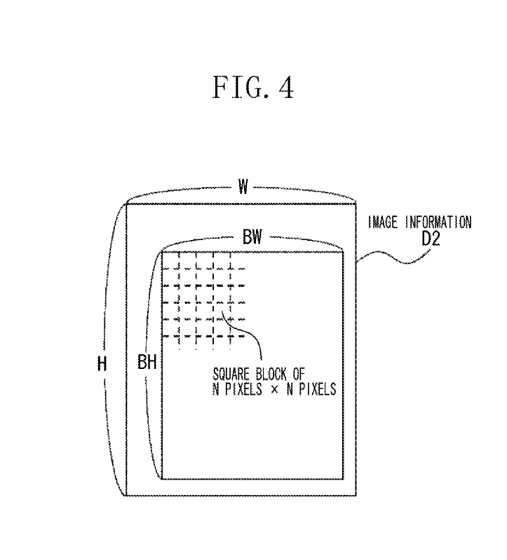

FIG. 4 illustrates an exemplary additional information embedding are a set on the image information D2. The additional information multiplexing unit 14 divides the additional information embedding area into a plurality of square blocks each having a size of N pixels×N pixels. In the exemplary embodiment, the division of blocks is not dependent on a horizontal size W and a vertical size H of the image information D2. The additional information multiplexing unit 14 sets the additional information embedding area involved in the area of image information D2. The additional information multiplexing unit 14 divides the additional information embedding area into a plurality of square blocks each having a size of N pixels×N pixels with reference to a horizontal size BW and a vertical size BH. The horizontal size BW of the additional information embedding area is smaller than the horizontal size W of the image information D2. The vertical size BH of the additional information embedding area is smaller than the vertical size H of the image information D2. The horizontal size BW is a multiple of a horizontal size of the square block having a size of N pixels×N pixels. The vertical size BH is a multiple of a vertical size of the square block having a size of N pixels×N pixels.

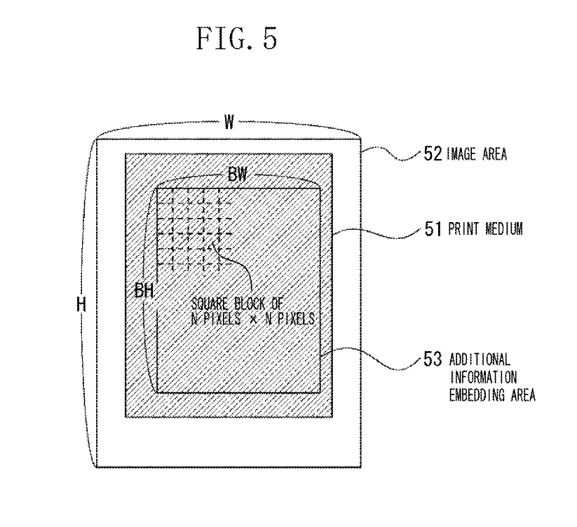

In step S35, the printer 15 receives image information D3 from the additional information multiplexing unit 14 and expands the image information D3 on an image area 52. The additional information embedding area 53 is set on a print medium 51 as illustrated in FIG. 5. The printer 15 prints the image on the print medium 51 and outputs the print image 16. The printer 15 is, for example, an inkjet printer or a laser printer that can perform halftone processing and realize a gradational expression.

FIG. 5 illustrates the image information D3 in the image area 52 printed on the print medium 51. According to the example illustrated in FIG. 5, the image area 52 is larger in size than the print medium 51. However, the print medium 51 and the image area 52 may have the same size. Or, the image area 52 is smaller in size than the print medium 51.

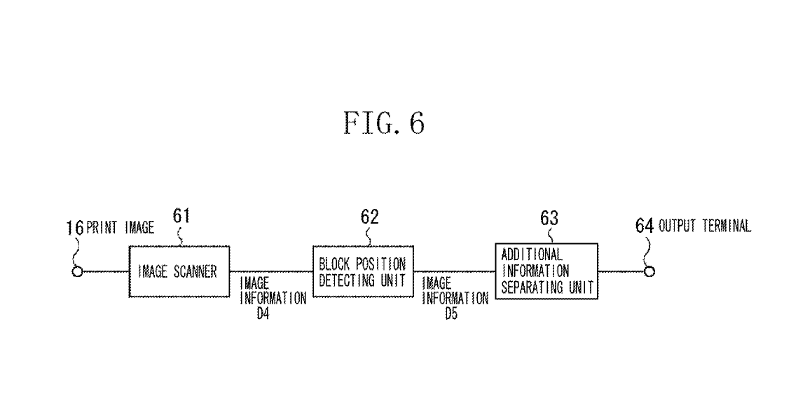

FIG. 6 is a block diagram illustrating an exemplary configuration of an additional information extracting apparatus according to an exemplary embodiment of the present invention. The additional information extracting apparatus can extract additional information from a printed image input by an image scanner. The additional information extracting apparatus includes an image scanner 61 that optically reads the print image 16 and converts the read image into image information D4, a block position detecting unit 62 configured to detect an accurate position of a block divided by the additional information multiplexing unit 14, and an additional information separating unit 63 configured to separate and reconstruct the additional information X based on the frequency analysis performed on a texture image of each block.

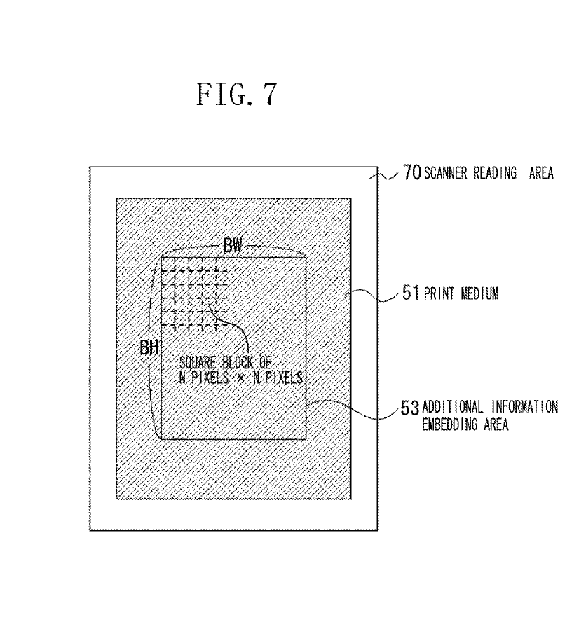

The image scanner 61 optically reads the print image 16 generated by the image processing apparatus illustrated in FIG. 1 and converts the read image 16 into the image information D4. FIG. 7 illustrates an exemplary image read by the image scanner 61. As illustrated in FIG. 7, the image scanner 61 optically reads the print medium 51 (i.e., the print image 16) including the additional information embedding area 53 involved in a scanner reading area 70. The image scanner 61 outputs the image information D4. The image scanner 61 is connected to the block position detecting unit 62.

The block position detecting unit 62 receives the image information D4 and detects an accurate position of a block where the additional information is embedded by the additional information multiplexing unit 14. As an exemplary method for detecting a block position, the block position detecting unit 62 can perform frequency characteristics analysis processing on a texture image involved in the image information D4 read by the image scanner 61 for each block by successively shifting the target position by one pixel or plural pixels.

Then, the block position detecting unit 62 can detect an accurate position of the block according to the frequency characteristics amount obtained through the above-described frequency characteristics analysis processing, or a code determination amount to be used when a code determination of the additional information X is performed.

The block position detecting unit 62 outputs image information D5 including the image information D4 and the detected block position information. The block position detecting unit 62 is connected to the additional information separating unit 63. The additional information separating unit 63 receives the image information D5 from the block position detecting unit 62.

The additional information separating unit 63 extracts, from the image information D5, the block position information detected by the block position detecting unit 62. Then, the additional information separating unit 63 performs frequency analysis processing on a texture image in each block with respect to one or plural extracted block positions. Then, the additional information separating unit 63 performs a code determination for each block embedding the additional information X and reconstructs the additional information X. To this end, the additional information separating unit 63 can use a conventional additional information separating method.

The number of blocks involved in the block position information detected by the block position detecting unit 62 may be different from the number of blocks involved in the block position information of the additional information embedded by the additional information embedding apparatus. In such a case, even if the additional information separating unit 63 extracts the block position information detected by the block position detecting unit 62 from the image information D5 and performs the additional information separation processing, the reconstructed information may be different from the additional information X embedded by the additional information embedding apparatus.

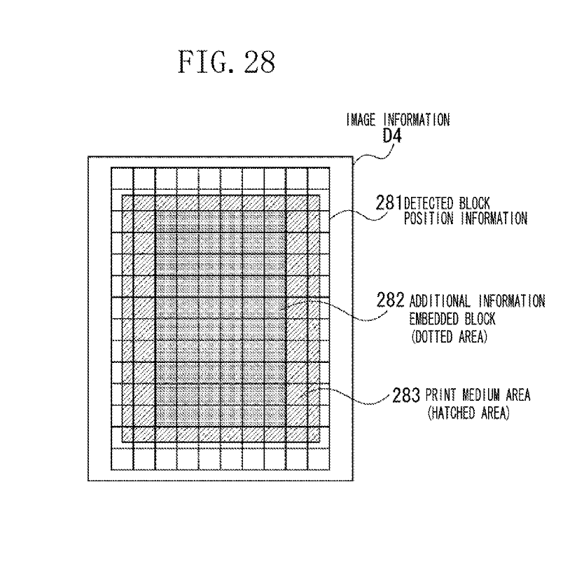

FIG. 28 illustrates an exemplary case where the number of blocks involved in the block position information detected by the block position detecting unit 62 is different from the number of blocks involved in the block position information of the additional information embedded by the additional information embedding apparatus.

For example, it is now assumed that the area of image information D4 read by the image scanner 61 is larger than an area 283 of a print medium printed by the additional information embedding apparatus. It is also assumed that an additional information embedded block 282 is smaller than the area 283 of the print medium. In this case, the block position detecting unit 62 detects block position information 281 representing a maximum number of blocks required to involve the entire region of the image information D4. Accordingly, the number of blocks involved in the detected block position information 281 is different from the number of blocks in the additional information embedded block 282.

As described above, the number of blocks involved in the block position information detected by the block position detecting unit 62 may differ from the number of blocks involved in the block position information of the additional information embedded by the additional information embedding apparatus. In this case, the additional information separating unit 63 performs additional information separation processing on the block position information detected by the block position detecting unit 62 and reconstructs the information. Then, the additional information separating unit 63 performs additional information extraction processing on the reconstructed information to extract the additional information X from the reconstructed information.

There are various methods for extracting additional information X from the reconstructed information after completing the additional information separation processing. An exemplary additional information extraction method utilizes a frequency characteristics amount (frequency analysis result) obtainable when a frequency analysis is performed on a texture image of each block in the additional information separation processing.

If a frequency characteristics amount of a portion where the additional information is embedded differs from that of a portion where the additional information is not embedded, the additional information separating unit 63 can perform feature extraction processing on the frequency characteristics value subjected to the frequency analysis and extract a block position where the additional information is embedded by the additional information embedding apparatus.

Another exemplary additional information extraction method performs frequency analysis processing on a texture image for each block in the additional information separation processing, then performs a code determination of a block where additional information is embedded, and reconstructs the additional information. In this case, the additional information separating unit 63 can utilize a code determination amount to be used in the code determination of a block where the additional information is embedded. If a code determination amount of a portion where the additional information is embedded differs from that of a portion where the additional information is not embedded, the additional information separating unit 63 can perform feature extraction processing on the code determination amount and extract a block position where the additional information is embedded by the additional information embedding apparatus.

As another exemplary additional information extraction method, the additional information embedding apparatus can embed specific additional information serving as a marker indicating position information of the additional information. When the additional information includes a marker indicating position information, the additional information separating unit 63 can perform the additional information separation processing and detect the marker from the reconstructed information. Thus, the additional information separating unit 63 can extract a block position where the additional information is embedded by the additional information embedding apparatus.

For example, an exemplary marker indicating position information of the additional information is a code pattern surrounding additional information (i.e., a block area to be embedded) embedded beforehand when the additional information embedding apparatus embeds additional information. Another exemplary marker is a code pattern embedded beforehand near four vertices of a block area to be embedded. Another exemplary marker is a code pattern embedded beforehand at a start block and an end block of the additional information to be embedded. In this manner, there are various methods for extracting the additional information X from reconstructed additional information that the additional information separating unit 63 can use. The additional information separating unit 63 outputs the extracted additional information X via an output terminal 64.

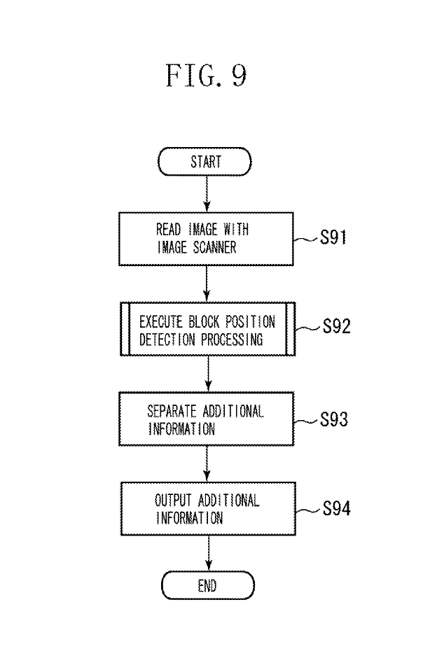

FIG. 9 is a flowchart illustrating an exemplary operation procedure of the image processing apparatus configured to receive the print image 16 read by the image scanner 61 and extract additional information X.

In step S91, the image scanner 61 optically reads the print image 16 and obtains the image information D4. In step S92, the block position detecting unit 62 performs block position detection processing on the image information D4 and detects block position information. The additional information separating unit 63 receives image information D5 which includes the block position information obtained by the block position detecting unit 62 and the image information D4 read by the image scanner 61.

In step S93, the additional information separating unit 63 analyzes frequency characteristics of a texture image of each block based on the detected block position information, and separates the additional information X. In step S94, the additional information separating unit 63 outputs the separated and reconstructed additional information X via the output terminal 64.

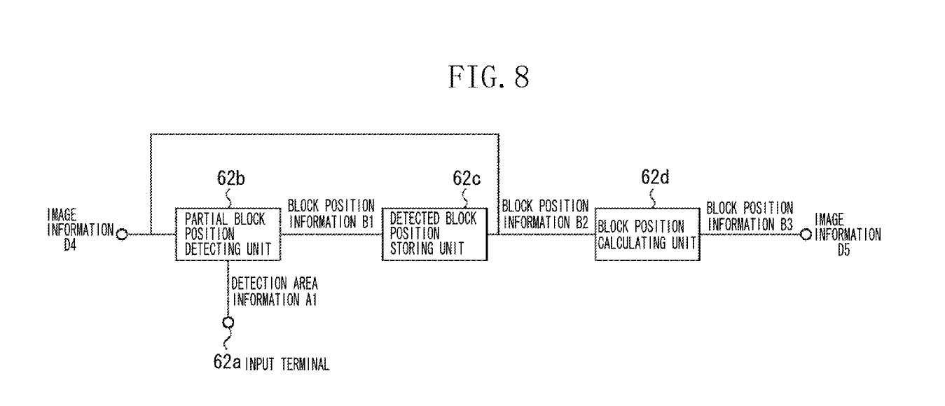

The control apparatus 20 illustrated in FIG. 2 can execute the processing of the image processing apparatus illustrated in FIG. 6 and FIG. 8 just like the processing of the image processing apparatus illustrated in FIG. 1. FIG. 8 is a block diagram illustrating a detailed configuration of the block position detecting unit 62 illustrated in FIG. 6. The block position detecting unit 62 includes a partial block position detecting unit 62b, a detected block position storing unit 62c, and a block position calculating unit 62d.

The block position detecting unit 62b receives the image information D4 read by the image scanner 61. The partial block position detecting unit 62b inputs detection area information A1 via an input terminal 62a. The block position detecting unit 62b detects a block position corresponding to an area designated by the detection area information A1 and outputs block position information B1 (i.e., the detected block position) to the detected block position storing unit 62c.

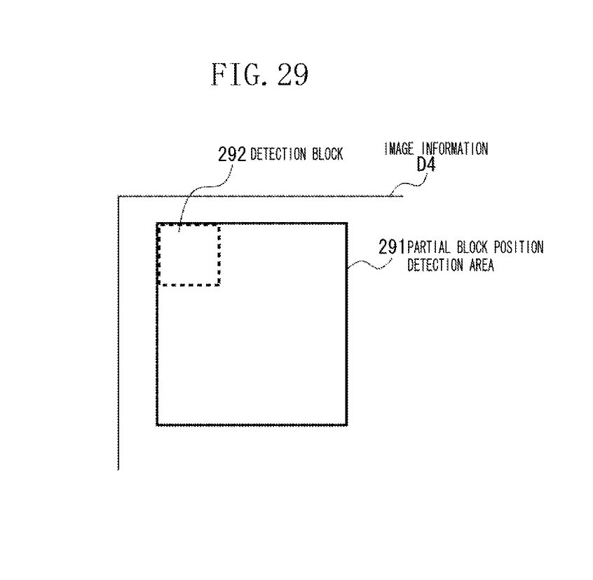

FIG. 29 illustrates exemplary processing performed by the block position detecting unit 62b. For example, if the detection area information A1 sets a partial block position detection area 291 on the image information D4, the block position detecting unit 62 performs block position detection processing in the partial block position detection area 291. An exemplary block position detection method includes analyzing a frequency component of a texture image by successively shifting the position of block 292 pixel by pixel within a partial block position detection area 291, and performing the additional information separation processing to separate additional information.

To this end, the block position detecting unit 62b calculates a frequency characteristics value to be used in the frequency analysis and an additional information determination value to be used in the additional information separation processing. Next, the block position detecting unit 62b performs feature extraction processing based on the frequency characteristics value and the additional information determination value, and detects a block position.

In this case, the frequency characteristics value and the additional information determination value obtained from a block position where the additional information is embedded differ from the values obtained from a block position where the additional information is not embedded or a block position deviated from the block position where the additional information is embedded.

The detected block position storing unit 62c stores the detected block position information B1 in a memory, determines whether to repeat the processing of the partial block position detecting unit 62b, and sets the detection area information A1. If the detected block position storing unit 62c determines to repeat the processing of the partial block position detecting unit 62b, the detected block position storing unit 62c sets the detection area information A1 and performs the processing of the partial block position detecting unit 62b. The detected block position storing unit 62c stores the detected block position information B1 in the memory again. Then, the detected block position storing unit 62c outputs block position information B2 including one or plural block position information B1 stored in the memory to the block position calculating unit 62d.

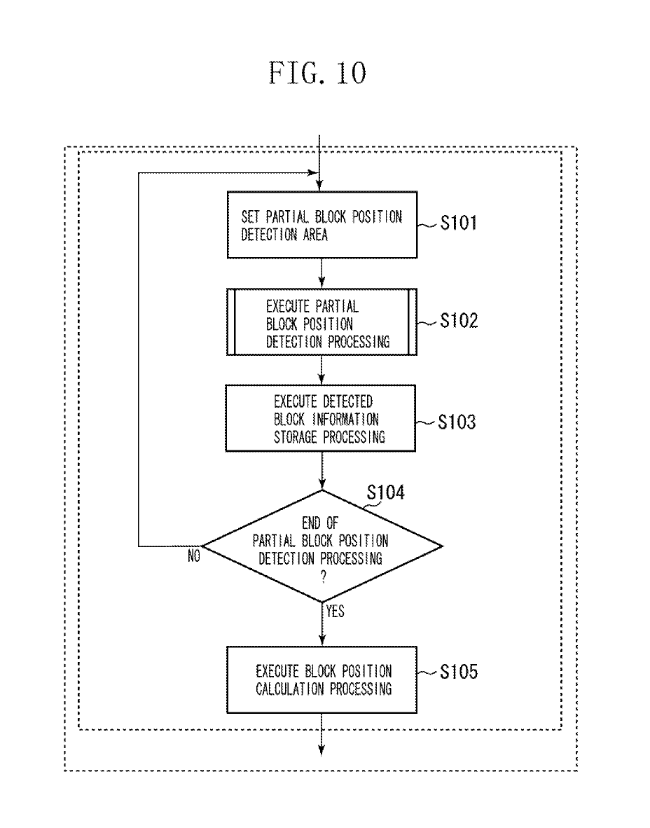

Next, with reference to the block position information B2, the block position calculating unit 62d calculates block position information B3 representing a position of a block area that can be embedded in the image information D4. The block position calculating unit 62d outputs image information D5 including the calculated block position information B3 and the image information D4. FIG. 10 is a flowchart illustrating an operation procedure of each unit in the block position detecting unit 62.

In step S101, the partial block position detecting unit 62b receives the image information D4 and the detection area information A1. The partial block position detecting unit 62b sets a partial block position detection area to detect partial block position information. In step 102, the partial block position detecting unit 62b performs block position detection processing within the area being set in step S101 and detects a block position.

In step S103, the detected block position storing unit 62c temporarily stores the detected block position in a memory. In step S104, the detected block position storing unit 62c determines whether to repeat the partial block position detection processing according to a relationship between the block position information stored in the memory and the detection area information A1. If the detected block position storing unit 62c determines to repeat the partial block position detection processing, the partial block position detecting unit 62b sets the detection area information A1 again and performs the partial block position detection processing. If the detected block position storing unit 62c determines not to repeat the partial block position detection processing, the processing flow proceeds to step S105 (i.e., block position calculation processing).

In step 105, the block position calculating unit 62d calculates a block position that can be embedded in the image information D4 based on the block position stored in the memory information B2. The block position calculating unit 62d outputs the image information D5 including the calculated block position information B3 and the image information D4.

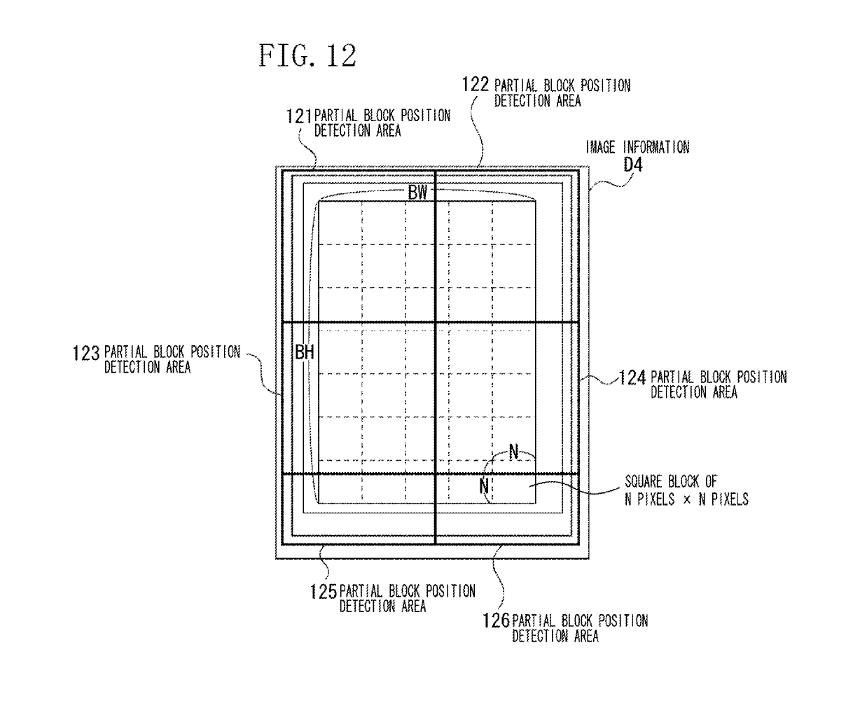

The partial block position detecting unit 62b sets a partial block detection area (step S101) and performs the partial block position detection processing (step 102). In the partial block detection area setting processing (step S101), the partial block position detecting unit 62b sets an area designated by the detection area information A1 input via the input terminal 62a. The partial block detection area setting processing (step S101) will be described below with reference to FIG. 12.

FIG. 12 illustrates an exemplary partial block position detection area positioned in the area of image information D4 obtained from the image scanner 61. The example illustrated in FIG. 12 includes six partial block position detection areas 121 to 126 involved in the area of image information D4. Each partial block position detection area is a rectangular area indicated by a bold line. The size and position of each partial block position detection area illustrated in FIG. 12 can be modified adequately. The number of partial block position detection areas is not limited to a particular value (e.g., 6). Each partial block position detection area can be set beforehand. An exemplary partial block position detection area may be set according to the input information of the image information D4. A next partial block position detection area can be set with reference to the detected block position information B1 having been once detected.

For example, if the area of image information D4 is divided into four areas, the detection area information A1 sets the four areas as partial block position detection areas. Furthermore, the detection area information A1 may include a processing interval for performing the partial block position detection processing. The detection area information A1 may include the next partial block position detection area being set according to the processing interval.

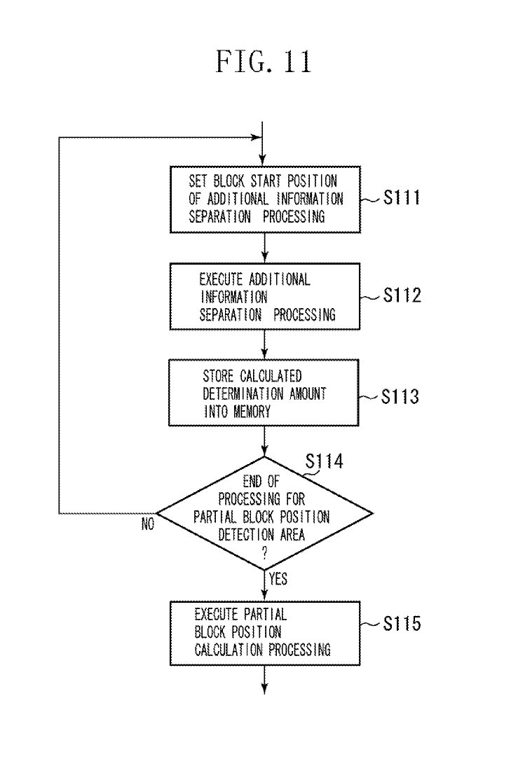

Next, in the partial block position detection processing (step 102), the partial block position detecting unit 62b performs block position detection processing within the area being set in step S101 and detects a block position. The partial block position detection processing (step S102) will be described with reference to FIG. 11. FIG. 11 is a flowchart illustrating exemplary partial block position detection processing (step S102).

In step S111, the partial block position detecting unit 62b sets a block start position where the additional information separation processing initiates. In step S112, the partial block position detecting unit 62b performs the additional information separation processing. More specifically, the partial block position detecting unit 62b performs frequency analysis processing on a texture image of each block from the block start position set in step S111 and calculates a frequency characteristics amount. Then, the partial block position detecting unit 62b calculates a code determination amount to be used in a code determination of a block where additional information is embedded, based on the frequency characteristics amount resulting from the frequency analysis.

In step 113, the partial block position detecting unit 62b stores the frequency characteristics amount and the code determination amount calculated in step S112 into a memory. In step S114, the partial block position detecting unit 62b determines whether the processing for the partial block position detection area set in step S101 has completed.

In step S115, the partial block position detecting unit 62b calculates a block position in the partial block position detection area based on the frequency characteristics amount (to be used in the separation of additional information) and the code determination amount (to be used in a code determination of an additional information embedded block) obtained in steps S111, S112, S113, and S114. The partial block position detecting unit 62b outputs block position information B1 representing the calculated block position.

Exemplary partial block position detection processing will be described below. It is assumed that the partial block position detection area set in step S101 is an area equivalent to 10,000 pixels having a horizontal size of 100 pixels and a vertical size of 100 pixels. First, in the block start position setting processing (step S111), the partial block position detecting unit 62b selects one pixel from the partial block position detection area (=10,000 pixels) and sets position information of the selected pixel as the block start position.

Next, in the additional information separation processing (step S112), the partial block position detecting unit 62b performs frequency analysis processing on a texture image of each block successively from the block start position set in step S111. Then, the partial block position detecting unit 62b performs a code determination of an additional information embedded block. The partial block position detecting unit 62b calculates a code determination amount to be used in the code determination of the additional information embedded block based on the frequency characteristics amount resulting from the frequency analysis.

The frequency area and the code determination amount calculated in the additional information separation processing (step S112) at a block position where the additional information is embedded differ from those calculated at a block position where the additional information is not embedded. Furthermore, the frequency area and the code determination amount calculated at a block position where the additional information is embedded differ from those calculated at a block position deviated from the block position where the additional information is embedded.

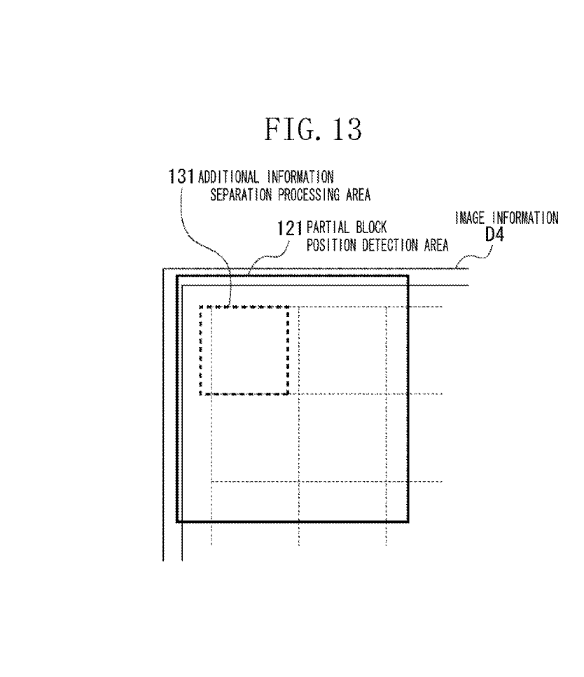

FIG. 13 illustrates an exemplary state where an additional information separation processing area 131 in the partial block position detection area 121 does not coincide with the position of the additional information embedded block.

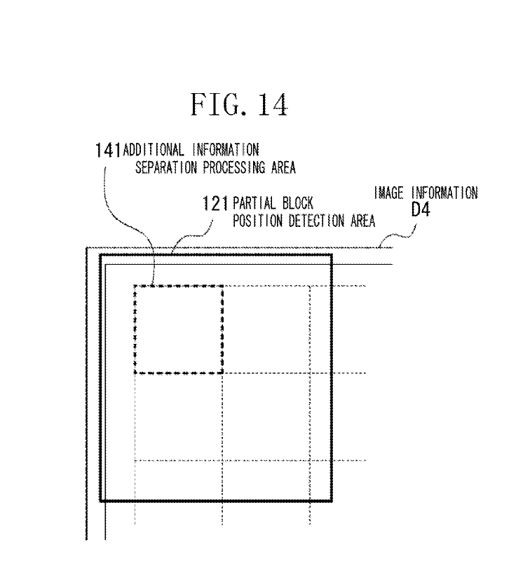

FIG. 14 illustrates an exemplary state where an additional information separation processing area 141 in the partial block position detection area 121 coincides with the position of the additional information embedded block. An exemplary determination amount becomes 100 if the partial block position detecting unit 62b performs the additional information separation processing (step S112) on the exemplary state illustrated in FIG. 13 (not coinciding with the position of the additional information embedded block) and 500 if performs on the exemplary state illustrated in FIG. 14 (coinciding with the position of the additional information embedded block).

Next, in the determination amount storage processing (step S113), the partial block position detecting unit 62b stores the frequency characteristics amount calculated in step S112 resulting from the frequency analysis and the code determination amount to be used in the code determination of an additional information embedded block in a memory. However, the partial block position detecting unit 62b may store only one of the frequency characteristics amount and the code determination amount in a memory.

Next, in the processing termination determination (step S114), the partial block position detecting unit 62b determines whether the additional information separation processing for the partial block position detection area of 10,000 pixels has completed. If the partial block position detecting unit 62b determines that the additional information separation processing for the partial block position detection area of 10,000 pixels is not yet completed, the partial block position detecting unit 62b performs the block start position setting (step S111) again. The partial block position detecting unit 62b shifts the block start position to the next pixel in the partial block position detection area. Namely, the partial block position detecting unit 62b repeats the above-described processing of steps S111, S112, S113, and S114 until the partial block position detecting unit 62b completes the additional information separation processing for the partial block position detection area of 10,000 pixels.

In the above-described embodiment, the partial block position detecting unit 62b shifts the block start position one pixel by one pixel. However, the shifting interval of the block start position is not fixed to a specific value. For example, the partial block position detecting unit 62b can set the block start position every two pixels, or randomly (e.g., in a staggered pattern).

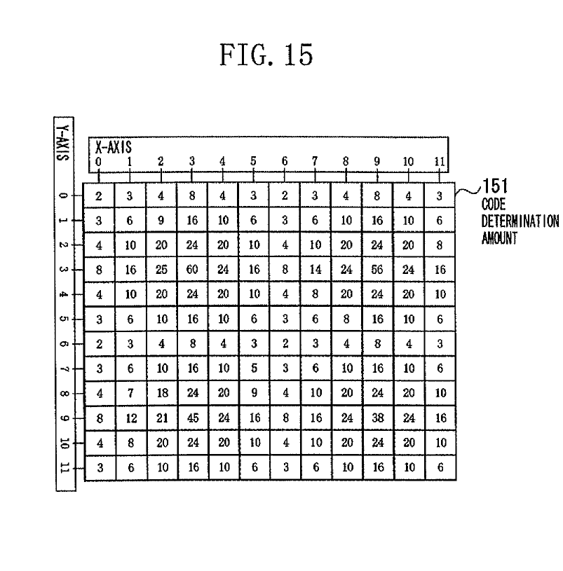

Next, in the partial block position calculation processing (step S115), the partial block position detecting unit 62b calculates a block position with reference to the determination amounts of 10,000 pixels stored in a memory. The partial block position calculation processing (step S115) will be described below with reference to FIG. 15. FIG. 15 illustrates exemplary code determination amounts of respective pixels obtained from a partial block position detection area by shifting one pixel by one pixel.

The following is an exemplary method for calculating a partial block position from the code determination amounts 151 illustrated in FIG. 15. For example, if there is a regularity or likelihood that a portion having a higher code determination amount may indicate the position of an additional information embedded block, the partial block position detecting unit 62b can identify a block position by checking whether the calculated code determination amount has a large value. To this end, the partial block position detecting unit 62b can detect a maximum value from the code determination amounts 151. If there is a regularity or likelihood that a portion having a lower code determination amount may indicate the position of an additional information embedded block, the partial block position detecting unit 62b can identify a block position by checking whether the calculated code determination amount has a small value. To this end, the partial block position detecting unit 62b can detect a minimum value from the code determination amounts 151.

According to the example illustrated in FIG. 15, a maximum value of the code determination amount is 60. The partial block position detecting unit 62b can identify the position having a code determination amount equal to 60 as a partial block position. When an upper left block of the partial block position detection area illustrated in FIG. 15 is a reference block having a coordinate value (X,Y)=(0,0), the partial block position detecting unit 62b determines that a partial block position has a coordinate value (X,Y)=(3,3). In this case, simply, the maximum value is obtained to detect the block position. However, other methods can be employed for calculating a partial block position.

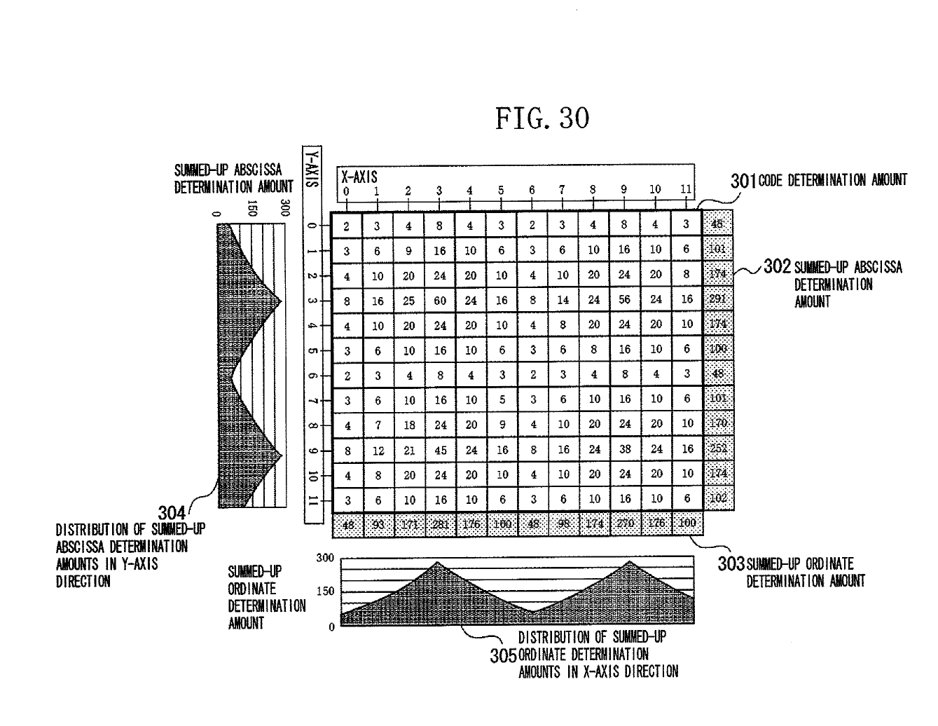

For example, there is a method for calculating a summed-up value of the calculated code determination amounts in each ordinate position and in each abscissa position and obtaining a maximum value. FIG. 30 includes graphs each illustrating a summed-up value of the calculated code determination amounts in each ordinate position and in each abscissa position. In FIG. 30, if an additional information embedded block has a size of 6×6 pixels, a maximum value appears every six pixels in the X-coordinate and the Y-coordinate. Accordingly, the partial block position detecting unit 62b detects a block portion where the maximum value appears every six pixels in the X-coordinate and the Y-coordinate. There are a total of 144 (=12×12) code determination amounts 301 in an area surrounded by a black bold frame, wherein each code determination amount indicates a calculated value in each pixel when a partial block position detection area has a size of 12×12 pixels.

In FIG. 30, a summed-up abscissa determination amount 302 is equal to a sum of twelve code determination amounts aligned in the X-axis direction. A summed-up ordinate determination amount 303 is equal to a sum of twelve code determination amounts aligned in the Y-axis direction. A graph 304 illustrates a distribution of summed-up abscissa determination amounts in the Y-axis direction. A graph 305 illustrates a distribution of summed-up ordinate determination amounts in the X-axis direction. Each of the graphs 304 and 305 expresses a characteristic feature (appearance of peaks) of the calculated determination amounts.

More specifically, one peak of the summed-up determination amount appears at the coordinate position (X,Y)=(3,3) and another peak appears at the interval of 6 pixels. Thus, the partial block position detecting unit 62b can regard the coordinate positions of respective peaks as representing an additional information embedded block.

There is another exemplary method for adding code determination amounts in each additional information embedded block and calculating a maximum value in each block based on the added value. As the additional information embedded block has a size of 6×6 pixels, the partial block position detecting unit 62b obtains a sum of 36 (=6×6) code determination amounts 301.

For example, the partial block position detecting unit 62b obtains a summed-up value of each block including 36 (=6×6) code determination amounts 301 by successively shifting the target block to the right from the upper left (=reference) coordinate point (0,0). The summed-up code determination amount in the first block is equal to 8 (=2+2+2+2) which is a sum of code determination amounts 301 at coordinate positions (0,0), (6,0), (0,6), and (6,6). The summed-up code determination amount in the next block is equal to 12 (=3+3+3+3) which is a sum of code determination amounts 301 at coordinate positions (1,0), (7,0), (1,6), and (7,6). The partial block position detecting unit 62b repeats this processing for 36 (=6×6) blocks.

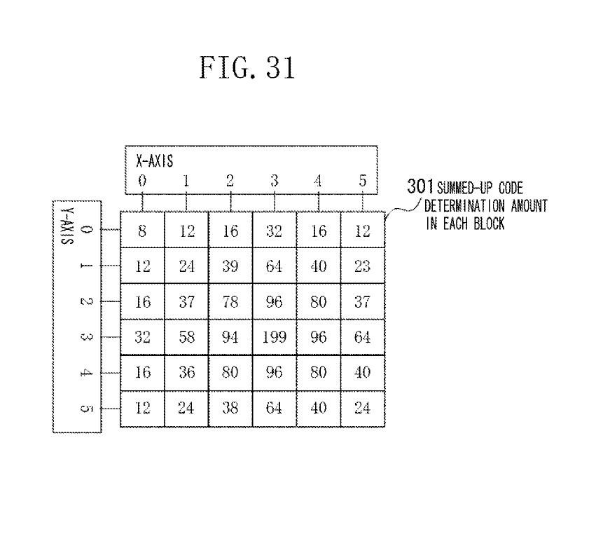

FIG. 31 illustrates a table of calculated summed-up code determination amounts in respective blocks each having a size of 6×6 pixels. In FIG. 31, a maximum summed-up code determination amount is 199 at the coordinate position (X,Y)=(3,3). Thus, the partial block position detecting unit 62b can regard the coordinate position (X,Y)=(3,3) as representing the position of an additional information embedded block.

There is another exemplary method for calculating a partial block position from the code determination amounts 151, according to which a partial block position is obtained based on a maximum value or a minimum value obtained from values added in units of a pixel, a certain number of pixels, a block, or a line. There is another exemplary method for calculating a partial block position, according to which a partial block position is obtained based on a maximum value or a minimum value obtained from values filtered in units of a pixel, a certain number of pixels, a block, or a line. In this manner, there are various methods that the partial block position detecting unit 62b can use to calculate a partial block position. The partial block position detecting unit 62b can use any other method if a partial block position can be detected by executing predetermined processing on determination amounts stored in a memory.

Furthermore, in the partial block position calculation processing S115, the partial block position detecting unit 62b calculates a partial block position using the code determination amount to be used in the code determination of an additional information embedded block in the separation processing of additional information. However, the partial block position detecting unit 62b can use a frequency characteristics amount resulting from the frequency analysis performed for analyzing a frequency component of a texture image in each block.

With the above-described processing, the partial block position detecting unit 62b detects a block position in a partial block position detection area set in step S101 and outputs the detected block position as the block position information B1. The partial block position detecting unit 62b is connected to the detected block position storing unit 62c. The detected block position storing unit 62c receives the block position information B1 from the partial block position detecting unit 62b.

The detected block position storing unit 62c performs the detection block storage processing (step S103) and determines a termination of the partial block position detection processing (step S104). In the detection block storage processing (step S103), the detected block position storing unit 62c successively stores the detected block position information B1 into a memory. For example, if six partial block position detection areas 121 to 126 are set as illustrated in FIG. 12, the partial block position detecting unit 62b detects a total of six block position information B1 from respective areas and stores them into a memory.

Next, in determining a termination of the partial block position detection processing (step S104), the detected block position storing unit 62c compares the stored information with the detection area information A1 received via the input terminal 62a. If two or more block position detection areas are set, the detected block position storing unit 62c determines whether the partial block position detecting unit 62b has completed the processing for each of the plural block position detection areas being set.

For example, if the detection area information A1 designates six partial block position detection areas 121 to 126 beforehand as illustrated in FIG. 12, the detected block position storing unit 62c determines whether the partial block position detecting unit 62b has completed the processing for all of the six areas 121 to 126. If the detected block position storing unit 62c determines to repeat the partial block position detection processing, the partial block position detecting unit 62b sets the detection area information A1 again and performs the partial block position detection processing. If the detected block position storing unit 62c determines to terminate the partial block position detection processing, the detected block position storing unit 62c performs the detection block storage processing (step S103) and outputs the block information B2 including the plural block information B1 stored in the memory.

According to the above-described exemplary determination of a termination of the partial block position detection processing, the information stored in a memory is compared with the detection area information A1. However, instead of setting the information beforehand, the detected block position storing unit 62c can set a partial block position detection area with reference to the input image information D4 and determine whether the processing of the partial block position detecting unit 62b has completed. Furthermore, the detected block position information B1 can be referred to in determining whether to execute the processing of the partial block position detecting unit 62b.

An exemplary processing for determining a termination of the processing of the partial block position detecting unit 62b will be described below with reference to FIG. 12. For example, if the image information D4 illustrated in FIG. 12 has an image size of 1000 pixels in the horizontal direction and 1200 pixels in the vertical direction, the detection area information A1 designates a start point having a coordinate value (X,Y)=(0,0) and a partial block position detection area having a horizontal size of 500 pixels and a vertical size of 500 pixels. In this case, setting of partial block position detection areas is performed so that the partial block position detection areas are involved in an area of the image information D4.

Four vertices of coordinate positions (0,0), (500,0), (0,500), and (500,500) define a partial block position detection area 121. Four vertices of coordinate positions (500,0), (1000,0), (500,500), and (1000,500) define a partial block position detection area 122. Four vertices of coordinate positions (0,500), (500,500), (0,1000), and (500,1000) define a partial block position detection area 123. Four vertices of coordinate positions (500,500), (1000,500), (500,1000), and (1000,1000) define a partial block position detection area 124.

If two partial block position detection areas 125 and 126 have a designated size (500×500 pixels) of the partial block position detection area, these areas 125 and 126 are not involved in the area of image information D4. In this case, the partial block position detecting unit 62b can cancel the block position detection processing in the partial block position detection areas 125 and 126.

If the partial block position detecting unit 62b performs the block position detection processing in the partial block position detection areas 125 and 126, the partial block position detection areas 125 and 126 are set to have a size fitting to the remaining area of the image information D4. Four vertices of coordinate positions (0,1000), (500,1000), (0,1200), and (500,1200) define the partial block position detection area 125. Four vertices of coordinate positions (500,1000), (1000,1000), (500,1200), and (1200,1200) define the partial block position detection area 126.

Then, the partial block position detecting unit 62b sets a smaller partial block position detection area having a size of 500×200 pixels (i.e., 500 pixels in the horizontal direction and 200 pixels in the vertical direction) and performs the block position detection processing in the partial block position detection areas 125 and 126. Then, the detected block position storing unit 62c can determine a termination of the processing of the partial block position detecting unit 62b.

With the above-described processing, the detected block position storing unit 62c stores one or plural partial block position information B1 in a memory and outputs the block position information B2 including the stored partial block position information B1. The detected block position storing unit 62c is connected to the block position calculating unit 62d. The block position calculating unit 62d receives the block position information B2 from the detected block position storing unit 62c.

The block position calculating unit 62d performs the block position calculation processing (step S105). In the block position calculation processing (step S105), the block position calculating unit 62d calculates the block position information B3 of the entire image information D4 based on the block position information B2 received from the detected block position storing unit 62c. The block position calculating unit 62d outputs the image information D5 including the calculated block position information B3 and the image information D4.

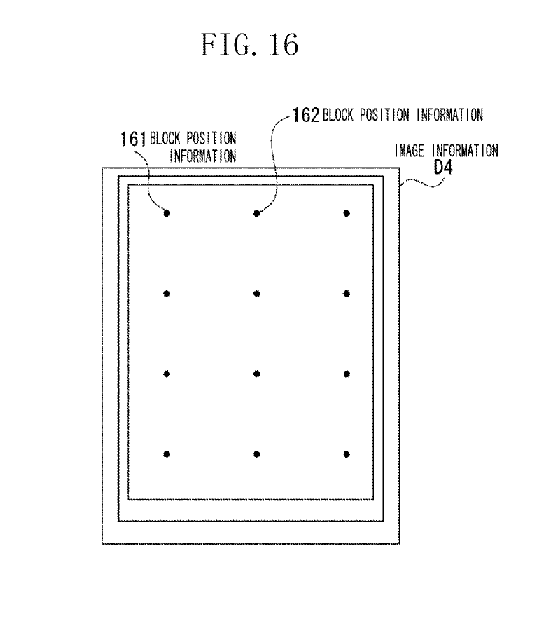

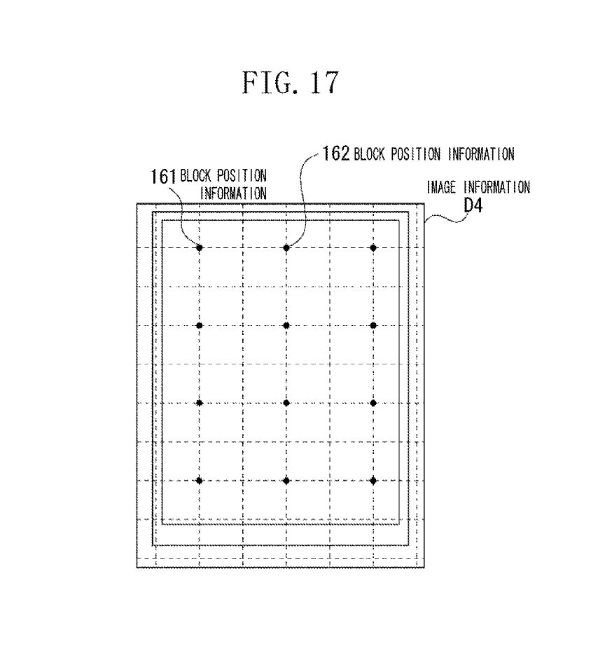

Exemplary block position calculation processing (step S105) will be described with reference to FIGS. 16 and 17. FIG. 16 illustrates a relationship between the image information D4 input into the block position calculating unit 62d and the block position information B2. FIG. 17 illustrates a result of block position information B3 calculated on the image information D4.

In FIG. 16, each black circle indicates detected block position information B2 in the image information D4. For example, block position information 161 and 162 are examples of black circles representing the block position information B2. An exemplary method for calculating the block position information B3 based on the block position information 161 and 162 can use a predetermined square block size of N pixels×N pixels and calculate the block position information B3 using an interior division calculation method and an exterior division calculation method.

For example, if the square block size of N pixels×N pixels is equivalent to a size of 200×200 pixels, the block position calculating unit 62d can execute the following calculation. When the block position information 161 has a coordinate value (X,Y)=(300, 100) and the block position information 162 has a coordinate value (X,Y)=(704, 100), an X-axis clearance between the block position information 161 and the block position information 162 is 404 (=704−300). The X-axis clearance is about two times (i.e., 404/200=2.02) a horizontal size of the square block size of N pixels×N pixels (=200×200 pixels).

Thus, two blocks are present in the X-axis clearance between the block position information 161 and the block position information 162. Hence, the block position calculating unit 62d calculates an interior division point between the block position information 161 and the block position information 162 and identifies a block existing on a coordinate point (502, 100). Furthermore, the block position calculating unit 62d calculates an exterior division point between the block position information 161 and the block position information 162 and identifies a block existing on a coordinate point (98, 100). In this manner, the block position calculating unit 62d can calculate all block positions on the image information D4 through the interior/exterior division processing performed on the block position information B2 and outputs the block position information B3.

In FIG. 17, each dotted line connects neighboring coordinate points of the detected block position information B3. Each block defined with a rectangular dotted line is a presumed additional information embedded block having a size of N×N pixels. The block position calculating unit 62d stores each lattice point where dotted lines cross each other as the block position information B3. The block position calculating unit 62d outputs the image information D5 including the image information D4 and the block position information B3. The block position calculating unit 62d is connected to the additional information separating unit 63. The additional information separating unit 63 receives the image information D5.

As described above, the first exemplary embodiment can detect a block position where additional information is embedded, without using a reference frame, from an image including additional information embedded therein. Furthermore, the first exemplary embodiment can detect a block position where additional information is embedded even if the embedded additional information is not dependent on an image size. Accordingly, the first exemplary embodiment can be applied to an apparatus configured to generate an image having a size larger than a print medium and cut a peripheral region of the image to be printed (such as, borderless pint). The present exemplary embodiment can detect a block position where the additional information is embedded as far as a print medium includes additional information embedded in each block at an inner region. As a result, the present exemplary embodiment can detect the additional information.

### Second Exemplary Embodiment

Hereinafter, an image processing apparatus according to a second exemplary embodiment of the present invention is described. In the above-described first exemplary embodiment, the partial block position detecting unit 62b detects one or plural block position information B1 and the detected block position storing unit 62c stores the detected block position information B1. Then, the detected block position storing unit 62c outputs the block position information B2. The block position calculating unit 62d directly uses the block position information B2. The block position calculating unit 62d calculates the block position information B3 based on the block position information B2. According to the first exemplary embodiment, if the partial block position detecting unit 62b erroneously detects the block position information B1 due to a noise or the like, the block position calculating unit 62d may erroneously calculate the block position information B3. Accordingly, the additional information separating unit 63 may not be able to accurately extract the additional information. The present exemplary embodiment intends to solve the above-described problem.

Similar to the first exemplary embodiment, the image processing apparatus according to the second exemplary embodiment includes an additional information embedding apparatus and an additional information extracting apparatus. The additional information embedding apparatus according to the second exemplary embodiment performs processing similar to that of the additional information embedding apparatus according to the first exemplary embodiment. The additional information extracting apparatus according to the second exemplary embodiment is similar to the additional information extracting apparatus according to the first exemplary embodiment, except the processing performed in the block position detecting unit 62 illustrated in FIG. 6.

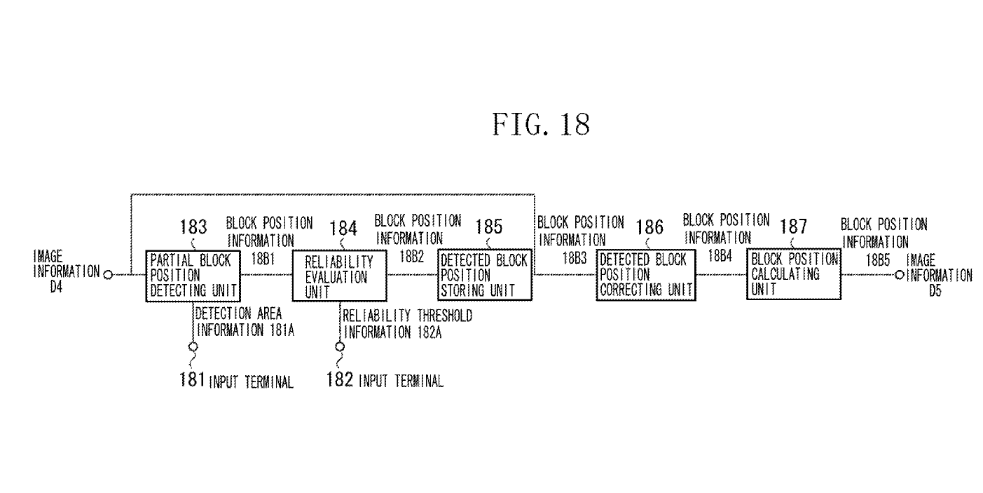

The block position detecting unit 62 according to the second exemplary embodiment can execute highly accurate block position detection processing, compared to the block position detecting unit 62 according to the first exemplary embodiment. FIG. 18 is a block diagram illustrating a detailed configuration of the block position detecting unit 62 according to the second exemplary embodiment.

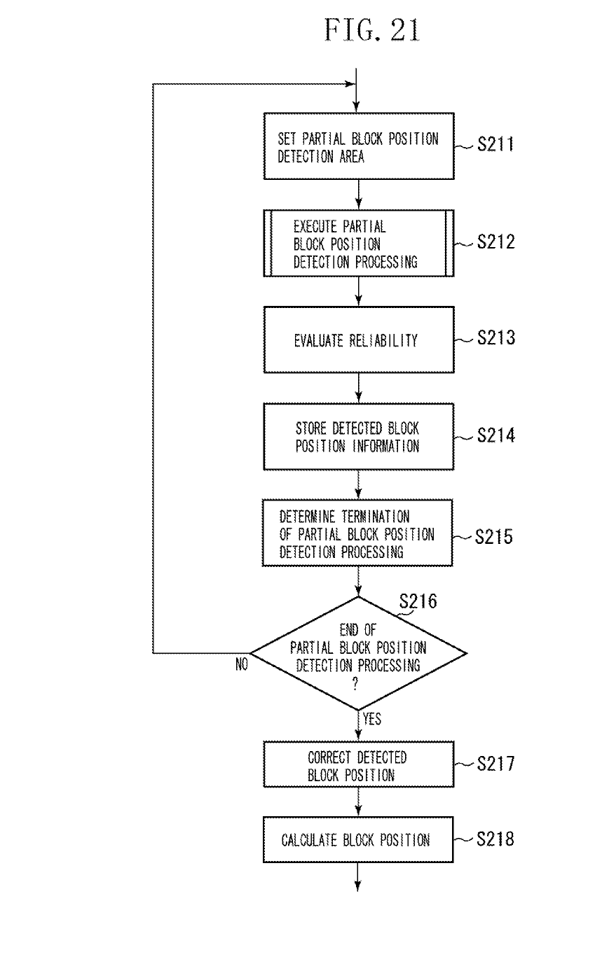

The block position detecting unit 62 according to the second exemplary embodiment, as illustrated in FIG. 18, includes a partial block position detecting unit 183, a reliability evaluating unit 184, a detected block position storing unit 185, a detected block position correcting unit 186, and a block position calculating unit 187. FIG. 21 is a flowchart illustrating an operation procedure of each unit of the block position detecting unit 62 according to the second exemplary embodiment.

In step S211, the partial block position detecting unit 183 receives image information D4 and detection area information 181A and sets a partial block position detection area (i.e., an area where partial block position information can be detected). In step 212, the partial block position detecting unit 183 performs texture frequency characteristics analysis processing for each block in the partial block position detection area being set in step S211. Then, the partial block position detecting unit 183 performs block position detection processing using the frequency characteristics amount calculated in the frequency characteristics analysis processing or a code determination amount used in the code determination of the additional information X.

In step S213, the reliability evaluating unit 184 performs reliability determination processing on partial block position information 18B1 received from the partial block position detecting unit 183 based on a comparison with reliability threshold information 182A received via the input terminal 182. The reliability evaluating unit 184 uses the determination amount to be used in a separation of additional information which is used in the block position detection processing performed by the partial block position detecting unit 183. Then, the reliability evaluating unit 184 outputs block position information 18B2 including reliability evaluation value R and the block position information 18B1.

In step S214, the detected block position storing unit 185 stores the block position information 18B2 in a memory. In step S215, the detected block position storing unit 185 determines whether to repeat the partial block position detection processing according to a relationship between the block position stored in the memory and the detection area information 181A.

In step S216, if the detected block position storing unit 185 determines to repeat the partial block position detection processing, the processing flow returns to step S211 to execute the above-described processing again. Namely, the partial block position detecting unit 183 inputs the detection area information 181A again and performs the partial block position detection processing. If the detected block position storing unit 185 determines to terminate the partial block position detection processing, the processing flow proceeds to step S217 (i.e., detected block position correction processing).

In step S217, the detected block position correcting unit 186 performs detected block position correction processing using the block position stored in the memory and the reliability evaluation value R. In this correction processing, the detected block position correcting unit 186 interpolates a portion having a lower reliability by a portion having a higher reliability. In step S218, the block position calculating unit 187 calculates all block positions on the image information D4 with reference to the block position information 18B4 received from the detected block position correcting unit 186. The block position calculating unit 187 outputs image information D5 including block position information 18B5 and the image information D4.

The partial block position detecting unit 183 receives the image information D4 from the image scanner 61 and the detection area information 181A via the input terminal 181. Furthermore, the partial block position detecting unit 183 performs the block position detection processing within the area designated by the detection area information 181A and outputs the detected block position information 18B1. The detection area information 181A is similar to the detection area information A1 illustrated in FIG. 8.

The partial block position detection processing performed by the partial block position detecting unit 183 is similar to that of the partial block position detecting unit 62b described in the first exemplary embodiment. In the second exemplary embodiment, the partial block position detecting unit 183 outputs the block position information 18B1 including a frequency characteristics amount calculated in the frequency characteristics analysis processing which is used in a determination of the partial block position detection, or a code determination amount to be used in a code determination of the additional information X, in addition to the detected partial block position information.

The reliability evaluating unit 184 receives the image information D4 and the block position information 18B1 from the partial block position detecting unit 183 and the reliability threshold information 182A via the input terminal 182. The reliability evaluating unit 184 outputs the image information D4 and the block position information 18B2 including the reliability evaluation value R of the block position information 18B1.

The reliability threshold information 182A (i.e., a threshold to be used in a determination of reliability) is a frequency characteristics amount calculated in the frequency characteristics analysis processing which is used in a determination of a partial block position detection calculated by the partial block position detecting unit 183. Alternatively, the reliability threshold information 182A may be obtained from a comparison with a code determination amount to be used in a code determination of the additional information X. The reliability threshold information 182A can be a value having been set beforehand or a value being set according to the input block position information 18B1 or the image information D4.

When the reliability evaluation value R exceeds the reliability threshold information 182A, the reliability evaluating unit 184 determines that partial block position information detected by the partial block position detecting unit 183 has a higher reliability. The reliability can be expressed using two evaluation values (i.e., reliable or unreliable), or can be expressed using a level indicating reliability. For example, according to the example illustrated in FIG. 15, the partial block position detecting unit 183 detects a block position having a coordinate value (X,Y)=(3,3). A code determination amount to be used in a code determination is 60. The reliability evaluation value R is a threshold of 50 used in a comparison with the code determination amount. As the code determination amount detected by the partial block position detecting unit 183 is 60, the reliability evaluating unit 184 determines that the detected block has a higher reliability.

In the above-described embodiment, the reliability threshold information 182A is a threshold to be compared with a code determination amount in the code determination processing. However, the reliability threshold information 182A is not limited to the above-described threshold. For example, the reliability threshold information 182A may be a threshold to be compared with a frequency characteristics amount calculated in the frequency characteristics analysis processing. It is also useful to set both a threshold to be compared with a code determination amount in the code determination processing and a threshold to be compared with a frequency characteristics amount calculated in the frequency characteristics analysis processing.

Furthermore, the reliability threshold information 182A may be any evaluation values converted from the threshold to be compared with a code determination amount in the code determination processing and the threshold to be compared with a frequency characteristics amount calculated in the frequency characteristics analysis processing. Accordingly, the reliability evaluating unit 184 can set the reliability threshold information 182A with reference to any value calculated by the partial block position detecting unit 183 if the reliability evaluating unit 184 can output an evaluation result of reliability as the reliability evaluation value R.

Next, the detected block position storing unit 185 stores block position information 18B2 into a memory. The block position information 18B2 includes the block position information 18B1 detected by the partial block position detecting unit 183 and the reliability evaluation value R calculated by the reliability evaluating unit 184.

The processing in a case where two or more partial block position detection areas are set and the processing for determining whether to repeat the processing of the partial block position detecting unit 183 are similar to those described in the first exemplary embodiment and not described below. The detected block position storing unit 185 outputs block position information 18B3 that includes one or plural block position information 18B2 stored in the memory. The detected block position storing unit 185 is connected to the detected block position correcting unit 186. The detected block position correcting unit 186 receives the block position information 18B3.

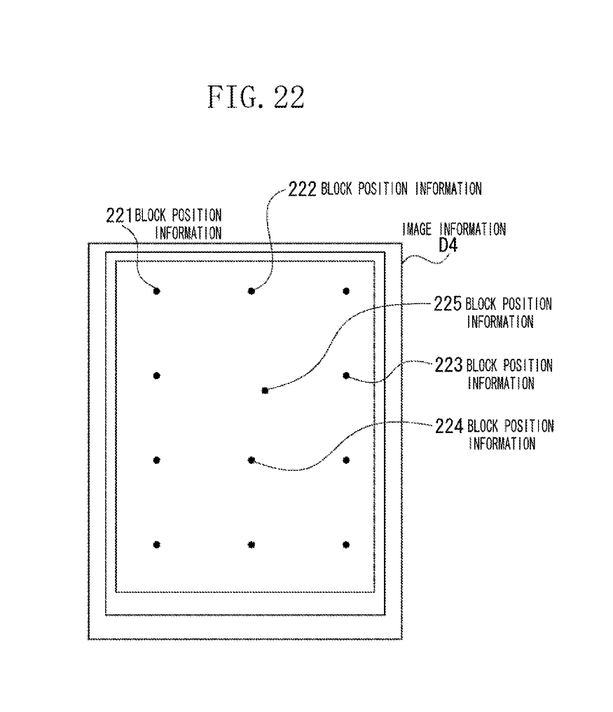

The detected block position correcting unit 186 corrects a portion having a lower reliability with reference to a portion having a higher reliability using the reliability evaluation value R of the block position information 18B3. FIG. 22 illustrates exemplary processing performed by the detected block position correcting unit 186. In FIG. 22, each black circle indicates block position information in the image information D4 detected by the partial block position detecting unit 183.

For example, the partial block position detecting unit 183 detects block position information 221 to 224 each having a higher reliability and block position information 225 having a lower reliability. As the lower-reliability block position information 225 is surrounded by four (upper, lower, right, and left) higher-reliability block position information 221 to 224, the detected block position correcting unit 186 interpolates the reliability information 225 using the block position information 221 to 224. According to an exemplary interpolation method, the detected block position correcting unit 186 calculates an X-axis coordinate value of the block position information 225 based on an interior division between two block position information 221 and 223 and calculates a Y-axis coordinate value of the block position information 225 based on an interior division between two block position information 222 and 224.

Furthermore, the partial block position detecting unit 183 may detect block position information 221, 222, and 227 each having a higher reliability and block position information 225 having a lower reliability. In this case, the detected block position correcting unit 186 interpolates the reliability information 225 using the block position information 221, 222, and 227. In this case, according to an exemplary interpolation method, the detected block position correcting unit 186 can obtain a distance between two block position information 221 and 227 and interpolate the block position information 225 by adding the obtained distance to the block position information 222. Thus, the block position information 225 can be obtained.

There are many exemplary methods for correcting (interpolating) block position information of a lower reliability portion with reference to a positional relationship with higher reliability portions. Therefore, the correcting method is not limited to the above-described method.

The detected block position correcting unit 186 interpolates a block position having a lower reliability information by a block position having a higher reliability information, and outputs the block position information 18B4 including the image information D4 and the interpolated block position information. The detected block position correcting unit 186 is connected to the block position calculating unit 187. The block position calculating unit 187 receives the block position information 18B4 from the detected block position correcting unit 186.

The block position calculating unit 187 performs calculation processing similar to that of the block position calculating unit 62d. In the second exemplary embodiment, components similar to those of the first exemplary embodiment are denoted by the same reference numerals and not described in detail. As described above, the second exemplary embodiment evaluates a reliability of detected block position information and interpolates a lower-reliability portion by higher-reliability portions. Thus, the second exemplary embodiment can realize highly accurate block position detection processing.

### Other Exemplary Embodiments

The present invention can be applied to a system including a plurality of devices (e.g., host computer, interface device, reader, printer, etc). Furthermore, the present invention can be applied to a single device, such as a copying machine or a facsimile apparatus.

Furthermore, software program code for realizing the functions of the above-described exemplary embodiments can be supplied to a system or an apparatus including various devices. A computer (or CPU or micro-processing unit (MPU)) in the system or the apparatus can execute the program to operate the devices to realize the functions of the above-described exemplary embodiments. Accordingly, the present invention encompasses the program code installable on a computer when the functions or processes of the exemplary embodiments can be realized by the computer.

In this case, the program code itself can realize the functions of the exemplary embodiments. The equivalents of programs can be used if they possess comparable functions. Furthermore, the present invention encompasses supplying program code to a computer with a storage (or recording) medium storing the program code. In this case, the type of program can be any one of object code, interpreter program, and OS script data. A storage medium supplying the program can be selected from any one of a floppy disk, a hard disk, an optical disk, a magneto-optical (MO) disk, a compact disk-ROM (CD-ROM), a CD-recordable (CD-R), a CD-rewritable (CD-RW), a magnetic tape, a nonvolatile memory card, a ROM, and a DVD (DVD-ROM, DVD-R).

The method for supplying the program includes accessing a web site on the Internet using the browsing function of a client computer, when the web site allows each user to download the computer program of the present invention, or compressed files of the programs having automatic installing functions, to a hard disk or other recording medium of the user.

Furthermore, the program code constituting the programs of the present invention can be divided into a plurality of files so that respective files are downloadable from different web sites. Namely, the present invention encompasses World Wide Web (WWW) servers that allow numerous users to download the program files so that the functions or processes of the present invention can be realized on their computers.

Enciphering the programs of the present invention and storing the enciphered programs on a CD-ROM or comparable recording medium is an exemplary method when the programs of the present invention are distributed to the users. The authorized users (i.e., users satisfying predetermined conditions) are allowed to download key information from a page on the Internet. The users can decipher the programs with the obtained key information and can install the programs on their computers. When the computer reads and executes the installed programs, the functions of the above-described exemplary embodiments can be realized.

Moreover, an operating system (OS) or other application software running on a computer can execute part or all of actual processing based on instructions of the programs. Additionally, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-334431 filed Dec. 12, 2006, which is hereby incorporated by reference herein in its entirety.

What is claimed is:

1. An apparatus operable to receive an image of a print medium including additional information embedded therein and process the received image, the apparatus comprising:
a determination amount calculating unit configured to calculate a determination amount to be used in a determination of contents involved in the additional information embedded in the received image; and
a block position detection unit configured to detect a block position where the additional information is embedded in the received image according to the determination amount calculated by the determination amount calculating unit.

2. The apparatus according to claim 1, further comprising:
a separating unit configured to separate the additional information from the received image based on the block position detected by the block position detection unit.

3. The apparatus according to claim 1, wherein the determination amount calculated by the determination amount calculating unit is a frequency characteristics amount calculated in frequency characteristics analysis processing performed on a texture image of each block.

4. The apparatus according to claim 1, wherein the determination amount calculated by the determination amount calculating unit is a code determination amount to be used in a code determination of the additional information.

5. The apparatus according to claim 1, wherein the determination amount calculated by the determination amount calculating unit at a block position where the additional information is embedded has a value different from a value calculated at a block position where the additional information is not embedded.

6. The apparatus according to claim 1, wherein the determination amount calculated by the determination amount calculating unit at a block position where the additional information is embedded has a value different from a value calculated at a block position deviated from the block position where the additional information is embedded.

7. The apparatus according to claim 1, wherein the determination amount calculating unit calculates a determination amount of a block on the read image by successively shifting a target position by one or plural pixels.

8. The apparatus according to claim 1, wherein the block position detection unit includes a feature extraction unit configured to extract a feature quantity from the determination amount calculated by the determination amount calculating unit, and a block position calculating unit configured to calculate a block position where the additional information is embedded based on the feature quantity extracted from the feature extraction unit.

9. The apparatus according to claim 8, wherein the feature extraction unit detects a maximum value or a minimum value of the determination amount calculated by the determination amount calculating unit as the feature quantity, and the block position calculating unit identifies a position of the feature quantity representing the maximum value or the minimum value detected by the feature extraction unit as the block position where the additional information is embedded.

10. The apparatus according to claim 8, wherein the feature extraction unit adds determination amounts calculated by the determination amount calculating unit at predetermined intervals and detects a maximum value or a minimum value of a summed-up determination amount as a feature quantity, wherein the block position calculating unit identifies a position of the feature quantity representing the maximum value or the minimum value detected by the feature extraction unit as the block position where the additional information is embedded.

11. The apparatus according to claim 8, wherein the feature extraction unit adds determination amounts calculated by the determination amount calculating unit at each abscissa position and each ordinate position and detects a feature quantity representing a maximum value or a minimum value of a summed-up determination amount in each abscissa position and each ordinate position, wherein the block position calculating unit identifies an overlapped position of feature quantities representing the maximum value or the minimum value in each abscissa position and the maximum value or the minimum value in each ordinate position detected by the feature extraction unit as the block position where additional information is embedded.

12. The apparatus according to claim 8, wherein the feature extraction unit adds filtered values of determination amounts calculated by the determination amount calculating unit at each abscissa position and each ordinate position and detects a feature quantity representing a maximum value or a minimum value of a summed-up determination amount in each abscissa position and each ordinate position, wherein the block position calculating unit identifies an overlapped position of feature quantities representing the maximum value or the minimum value in each abscissa position and the maximum value or the minimum value in each ordinate position detected by the feature extraction unit as the block position where additional information is embedded.

13. The apparatus according to claim 1, further comprising:
an area setting unit configured to set a plurality of areas on the received image;
wherein a determination amount calculating unit configured to calculate a determination amount to be used in a determination of contents involved in the additional information in each of the plurality of areas set by the area setting unit.

14. The apparatus according to claim 1, further comprising:
a reliability determination unit configured to calculate a reliability determination value representing a reliability of the block position detected by the block position detection unit with reference to the determination amount calculated by the partial determination amount calculating unit;
a detected block position correction unit configured to interpolate a block position having a lower reliability by at least one block position having a higher reliability if reliability determination values calculated by the reliability determination unit are different; and
a block area calculating unit configured to identify a block area where the additional information is embedded in the received image from a plurality of block areas determined by the detected block position correction unit based on interpolating of the block positions.

15. The apparatus according to claim 14, wherein the reliability determination unit performs frequency characteristics analysis processing on a texture image of each block, and evaluates a reliability according to a frequency characteristics amount calculated in the frequency characteristics analysis processing or a code determination amount to be used in a code determination of the additional information.

16. The apparatus according to claim 14, wherein the reliability determination unit performs frequency characteristics analysis processing on a texture image of each block, and evaluates a reliability according to both a frequency characteristics amount calculated in the frequency characteristics analysis processing and a code determination amount to be used in a code determination of the additional information.

17. The apparatus according to claim 14, wherein the reliability determination unit evaluates the reliability of each block position with a value indicating a reliable block position or a value indicating an unreliable block position.

18. The apparatus according to claim 14, wherein the detected block position correction unit corrects the block position having a lower reliability with reference to at least one block positions each having a higher reliability.

19. The apparatus according to claim 14, wherein the detected block position correction unit corrects the block position having a lower reliability with reference to the at least one block position each having a higher reliability using interior division processing and exterior division processing.

20. The apparatus according to claim 14, wherein the area setting unit changes setting areas according to a size of the read image.

21. The apparatus according to claim 14, wherein the area setting unit changes setting areas according to block position information detected by the partial block position detection unit.

22. A method for processing an image of a print medium including additional information embedded therein, the method comprising:
calculating a determination amount to be used in a determination of contents involved in the additional information embedded in the received image; and
detecting a block position where the additional information is embedded in the received image according to the calculated determination amount.

23. The method according to claim 22, further comprising:
separating the additional information from the received image based on the detected block position.

24. A computer program causing a computer to operate as the image processing apparatus according to claim 1.

25. A computer-readable storage medium storing the computer program according to claim 24.
